(19) United States
(12) Patent Application Publication
(10) Pub. No.: US 2025/0075850 A1
(43) Pub. Date: Mar. 6, 2025

(54) Curvature-Adjustable Magnetic Strut

(71) Applicant: Jonathan Worden, Twin Falls, ID (US)

(72) Inventor: Jonathan Worden, Twin Falls, ID (US)

(21) Appl. No.: 18/952,519

(22) Filed: Nov. 19, 2024

Related U.S. Application Data
(62) Division of application No. 29/819,235, filed on Dec. 14, 2021, now Pat. No. D057546.

(51) Int. Cl. F16M 13/02; F16L 3/02

(52) U.S. Cl. CPC F16M 13/02; F16L 3/02

(57) ABSTRACT

The present subject matter is directed to a curvature-adjustable magnetic strut for securing pipe, conduit and tubing to a curved structure for storing liquids and gases, such as large fuel tanks. More particularly, several variants of a curvature-adjustable magnetic strut are disclosed which enables varying curved or flat surfaces to be accommodated in securing pipe, conduit and tubing to a cylindrical tank, whether that tank be in a vertical or a horizontal orientation or position. The curvature-adjustable magnetic strut comprises a strut affixed to a base plate having three or more magnets attached. In operation, the base plate is operably curvature-adjusted using one or more curvature-adjustment screw components. In related embodiments, varying length struts with varying length single-and double-hinged bracket assemblies are secured to the securing strut plates and magnet base plates including two or more magnets are used to adjust for varying tank curvature.

### REFERENCE TO RELATED APPLICATIONS

The present nonprovisional Utility patent application is a Division of U.S. application Ser. No. 17/711,178 filed Apr. 1, 2022, which-in turn-is a continuation-in-part (“CIP”) of Design patent application U.S. Ser. No. 29/819,235 filed Dec. 14, 2021, the priority of both of which are hereby incorporated by reference pursuant to 35 USC §§ 120, 121.

### FIELD OF THE INVENTION

This application relates to a curvature-adjustable magnetic strut to secure pipe, conduit, and/or tubing to curved structures, such as fuel tanks for storing liquids and/or gases. More particularly, a variety of curvature-adjustable magnetic struts are disclosed, enabling curved surfaces to be accommodated to secure pipe, conduit, and/or tubing to cylindrical tanks, whether such tanks are vertical, such as typical fuel storage tanks, or horizontal, such as typical horizontal propane tanks. A curvature-adjustable magnetic strut comprises a strut affixed to a base plate having three or more attached magnets. In operation, the base plate can be curvature adjusted using one or more adjustment screws. In embodiments, varying length struts with varying length hinged brackets, fixed to base plates having two or more magnets, are used to adjust for varying tank curvature.

### BACKGROUND OF THE INVENTION

Strut channel, often referred to by one of several manufacturer trade names, such as UNISTRUT®, is a standardized formed structural system used in the construction and electrical industries for light structural support, often for supporting wiring, plumbing, or mechanical components such as air conditioning or ventilation systems. A strut is usually formed from a metal sheet, folded over into an open channel shape with inwards-curving lips to provide additional stiffness and as a location to mount interconnecting components. Increasingly, struts are being constructed from fiberglass, a highly corrosion-resistant material that's known for its lightweight strength and rigidity. Struts usually have holes of some sort in the base, to facilitate interconnection or fastening a strut to underlying structure. One advantage of strut channels in construction is that there are many options available for rapidly and easily connecting lengths together and other items to the strut channel, using specialized strut-specific fasteners and bolts. They can be assembled very rapidly with minimal tools and only moderately trained labor, which reduces costs significantly in many applications. A strut channel installation also can often be modified or added-to relatively easily if needed. One such alternative to strut channels for most applications is custom fabrication using steel bar stock and other commodity components, requiring welding or extensive drilling and bolting, having none of the above advantages.

In US units (which, according to Wikipedia, are English or Imperial units), a typical strut channel forms a box 1 ⅝-inch wide by 1 ⅝-inch long. In metric units, this is a 41-mm×41-mm box. Several additional sizes and combined shapes are manufactured. Basic strut channel comes in an open box section, 1 ⅝-by 1 ⅝-inch (41-×41-mm) cross section. A half height (1 ⅝-inch wide, 13/16-inch tall, 41-×21-mm) rectangular cross section version is also available, used mostly where it is mounted directly to walls, because it has significantly less stiffness and capability of supporting loads across an open space or brace. A rectangular deep channel 2 7/16-inches tall and 1 ⅝-inch wide is also made (82-×41-mm). Material used to form channels is typically 12-gauge (0.1046-inch) or 14-gauge (0.0747-inch) thick sheet metal, or 1.5-mm×2.5-mm, in metric units.

Regarding channel types, several variations are available with different hole patterns for mounting to walls and supports. Solid channel with no holes pre-drilled must either be drilled on site or mounted in another fashion. Hole-punched channel has round holes, large enough for ⅝-inch threaded steel rod or bolts, punched through a channel topside along 1 ⅞-inch centers. Half-slot channel has short, rounded end slots punched through along 2-inch centers. Slotted channel has longer slots, on 4-inch centers. In metric-dimension system-based products, rectangular eyelets are about 11-×13-mm. And shapes are manufactured with two lengths of channel welded together back-to-back, or three or four welded together in various patterns, forming stronger structural elements. Strut is normally made of sheet steel, with a zinc coating (galvanized), painted, with an epoxy or powder coating, or another finish. Strut channel may also be made from stainless steel, to use where rusting poses problems (e.g., outdoors, facilities with corrosive materials), from aluminum, when weight is an issue, or from fiberglass, when used near corrosive environments. Inwards-facing lips on an open side of strut channel are routinely used to mount special nuts, braces, connecting angles, and other types of interconnection mechanisms and/or devices, to join lengths of strut channel together or to connect pipes, wire, other structures, threaded rod, bolts, or walls within strut channel structural systems.

Strut channel is commonly used to mount, brace, support, and connect lightweight structural loads in building construction. These include pipes, electrical and data wire, mechanical systems such as ventilation, air conditioning, and other mechanical systems. Objects can be attached to the strut channel with a bolt, threaded into a channel nut, that may have a spring to ease installation. Circular objects such as pipes or cables may be attached with straps that have a shaped end to be retained by the channel. Strut channel is also used for other applications that require a strong framework, such as workbenches, shelving systems, equipment racks, etc. Specially made sockets are available to tighten nuts, bolts, etc. inside a channel, as normal sockets are unable to fit through the opening.

Most steel constructed fuel storage tanks are vertical cylinders, such as a common above-ground gas storage tank. Typically, steel-constructed above-ground gas-storage tanks are horizontal cylinders with rounded ends, such as common propane storage tanks. Often there is a need to affix or support piping, conduit, or tubing to above-ground fuel-storage tanks and/or propane-storage tanks. After these tanks are filled with fuel and/or gas-welding to them, drilling through portions of them to fix bolts, including using screws and/or bolts to support piping are no longer options. Moreover, anyone other than a manufacturer welding on a tank would void any tank warranty. Therefore, there exists a need for a quick and easy way of installing piping on a fuel tank containing flammable fuel or flammable gas without welding or drilling that would jeopardize the safety of installers.

Piping, conduit, and/or tubing to be affixed to steel-constructed fuel-storage tanks and/or gas-storage tanks generally are first anchored to the ground. Means of fastening or clamping, is next arranged or set up at the top of the storage tank. When employing such common methods between a tank top and bottom, there is generally no fixed support made between the ground and the top of the tank, even though many tanks may often be 40 feet or more in height. In the past, attempts have been made to tie wire around a tank to hold piping to a tank. However, this has not been found successful. Therefore, there is a need for an apparatus to fasten strut for pipe support on above-ground fuel-storage tanks and gas-storage tanks quickly and effectively without the need to weld or drill holes.

Whereas, strut—such as UNISTRUT® is widely used to support piping, conduit, and tubing to structures such as fuel tanks—there exists a long felt need to be able to mount the strut to the tank especially is a case where a fuel tank is full of fuel, without the use of welding or drilling holes, or screwing into the fuel storage tank in an unsafe manner.

Before explaining at least one embodiment of a Curvature-Adjustable Magnetic Strut in greater detail, it is to be understood that the present design is not limited in its application to details of construction or to the arrangement of the components set forth in the following description or illustrated in the drawings. A Curvature-Adjustable Magnetic Strut is accordingly capable of other embodiments and of being practiced and carried out in various ways. Moreover, it is to be understood that the phraseology and terminology employed herein are for the purpose of description and should not be regarded as limiting.

### SUMMARY OF THE INVENTION

A preferred embodiment of a Curvature-Adjustable Magnetic Strut of the present subject matter advantageously allows for quick and easy installation of pipe, conduit, and tubing by installers onto the outer surfaces of variably curved storage tanks, especially fuel-storage tanks and gas-storage tanks where the fuel and gas are flammable materials.

One advantage of the Curvature-Adjustable Magnetic Struts of the present subject matter is they allow toolless installation by magnetic attachment of struts to tank structure.

Another advantage of the Curvature-Adjustable Magnetic Strut is that it allows for installation without having to weld on, or drill into, fuel storage tanks, especially when they are full or partially full of flammable fuel or flammable gas and it is unsafe to weld or drill.

Yet another advantage of the Curvature-Adjustable Magnetic Strut of the present subject matter is that it adjusts to any tank curvature, allowing the magnets to securely old curvature-adjustable magnetic strut assemblies to fuel and/or gas tanks as required.

These and other advantages of the Curvature-Adjustable Magnetic Strut of the present subject matter, along with a variety of novel features, which characterize the design are pointed out with particularity in the claims annexed hereto. For a better understanding of the Curvature-adjustable Magnetic Strut of the present subject matter, its operating advantages, and the specific objects attained by its uses, reference should be made to the accompanying drawing FIGS and associated description of the preferred and alternate embodiments of the Curvature-adjustable Magnetic Strut of the present subject matter. There has thus been outlined, rather broadly, important features of the design in order that the detailed description herein that follows may be better understood, and in order that the present contribution to the art may be better appreciated. There are additional features of the Curvature-adjustable Magnetic Strut of the present subject matter, described hereinbelow, supporting subject matter of the claims appended hereto.

An embodiment of a Curvature-Adjustable Magnetic Strut has a variable length strut member, securing strut base plates, one or more magnet base plates affixed to a variable length strut member, two or more magnets attached to each base plate, and one or more adjustment screws to adjust curvature of a base plate to match the curvature of a fuel tank having the curvature-adjustable magnetic strut assemblies installed thereon.

In certain alternate embodiments, the Curvature-Adjustable Magnetic Strut of the present subject matter may have a variable length strut member including securing strut base plates, one or more magnet base plates affixed to the variable length strut member, two or more magnets attached to each magnet base plate, and either two or more strut base plates secured single hinged bracket assemblies including one or more magnetic base plates affixed to each bracket assembly, or two or more strut base plates secured to double hinged bracket assemblies including one or more hinged magnetic base plates affixed to each hinged bracket assembly having at least one hinged magnetic base plate.

The Curvature-Adjustable Magnetic Strut primary features will include as prominent design and operational features:
a variable length strut member with securing strut base plates;
one or more magnet base plates affixed to the variable length strut member;
two or more magnets attached to each magnet base plate;
two or more strut base plates secured single hinged bracket assemblies including one or more magnetic base plates affixed to each bracket assembly; and
two or more strut base plates secured double hinged bracket assemblies including one or more hinged magnetic base plates affixed to each hinged bracket assembly having a hinged magnetic base plate.

With respect to the present patent specification, it is to be understood that optimum dimensional relationships for components of the Curvature-Adjustable Magnetic Strut of the present subject matter shall include variations in size, materials, shape, form, function, and manner of manufacture, assembly, operation, and/or use-as deemed anticipated by and/or obvious to a person of ordinary skill in the art (“POSITA”), and, further, that all equivalent relationships to the drawings and/or description in the specification are intended to be encompassed by the present disclosure. Therefore, the present disclosure is considered as embodying principles of the Curvature-Adjustable Magnetic Strut of the present subject matter. Furthermore, since modifications and/or design changes will occur to a POSITA, there is no desire to limit the Curvature-Adjustable Magnetic Strut to the construction and/or operation shown and described herein. Rather, all such modifications and/or equivalents are to be deemed as falling within the scope of the appended claims.

### BRIEF DESCRIPTION OF THE DRAWINGS

The accompanying drawings, which form a part of this specification and illustrate embodiments of the Curvature-Adjustable Magnetic Strut of the present subject matter, along with the description, serve to illustrate the principles of the present subject matter.

FIG. 1 presents a top and side elevational perspective view of a liquid storage tank having a fill pipe attached to an outer surface thereof using three curvature-adjustable magnetic strut units to secure a fill pipe to a tank, according to the present subject matter.

FIG. 2 depicts a top plan view of a vertical liquid storage tank having a fill pipe attached to the outer surface using three curvature-adjustable magnetic strut units to secure the fill pipe to the tank, as shown in FIG. 1, according to the present subject matter.

FIG. 3 depicts a side elevational view of a curvature-adjustable magnetic strut having three magnets affixed to a magnet base plate, according to the present invention.

FIG. 4 presents a top plan view of a curvature-adjustable magnetic strut having three magnets affixed to the magnet base plate, according to the present subject matter.

FIG. 5 presents a bottom view of a curvature-adjustable magnetic strut having three magnets affixed to the magnet base plate, according to the present subject matter.

FIG. 6 presents a front view of a curvature-adjustable magnetic strut that includes three magnets affixed to the magnet base plate, according to the present subject matter.

FIG. 7 presents a rear view of a curvature-adjustable magnetic strut that includes three magnets affixed to the magnet base plate, according to the present subject matter.

FIG. 8 is a top, side, and rear perspective view of a curvature-adjustable magnetic strut including three magnets affixed to a base plate, according to the present invention.

FIG. 9 is a bottom, side, and front perspective view of a curvature-adjustable magnetic strut with three magnets fixed to a base plate, pursuant to the present invention.

FIG. 10 is a side elevational view of a curvature-adjustable magnetic strut having three magnets affixed to a base plate, wherein curvature adjustment bolts are rotated and extended to adjust curvature of the base plate, according to the present subject matter.

FIG. 11 presents a front view of a curvature-adjustable magnetic strut having three magnets affixed to the magnet base plate, wherein curvature adjustment bolts are rotated and extended to adjust the curvature of the base plate, according to the present invention.

FIG. 12 is a top, side, and front perspective view of a curvature adjustable magnetic strut having three magnets fixed to a base plate, and curvature adjustment bolts rotated and extended to adjust curvature of a base plate, according to the present subject matter.

FIG. 13 is a top, side, and front perspective exploded view of a curvature adjustable magnetic strut with five magnets fixed to a base plate, according to the present invention.

FIG. 14 depicts a front exploded view of a curvature-adjustable magnetic strut having five magnets affixed to the magnet base plate, according to the present invention.

FIG. 15 is a bottom view of a curvature-adjustable magnetic strut having five magnets fixed to a base plate, and four stabilizing bolts, pursuant to the present invention.

FIG. 16 depicts a top plan view of a curvature adjustable magnetic strut having five magnets fixed to a base plate, and four stabilizing bolts, pursuant to the present invention.

FIG. 17 is a side elevational view of a curvature-adjustable magnetic strut with five magnets fixed to a base plate, and four stabilizing bolts, pursuant to the present invention.

FIG. 18 is a front view of a curvature-adjustable magnetic strut having five magnets affixed to a base plate, including four stabilizing bolts, according to the present invention.

FIG. 19 is a rear view of a curvature-adjustable magnetic strut having five magnets affixed to a base plate, including four stabilizing bolts, according to the present invention.

FIG. 20 is a top, side, and front view of a curvature-adjustable strut including five magnets fixed to a base plate, and four stabilizing bolts, pursuant to the present invention.

FIG. 21 depicts a bottom, a lateral side, and a rear perspective view of a curvature-adjustable magnetic strut including five magnets affixed to a magnetic base plate, wherein the base plate includes stabilizing bolts therein, according to the present subject matter.

FIG. 22 depicts a side elevational view of a curvature-adjustable magnetic strut assembly including five magnets affixed to a base plate assembly, wherein the base plate assembly includes four stabilizing bolts and adjustment screws extended therefrom for adjusting a curvature value for the base plate, in accord with the present subject matter.

FIG. 23 is a top, side, and rear perspective view of a curvature-adjustable magnetic strut having five magnets affixed to a base plate, and four stabilizing bolts, with adjustment screws extended to adjust curvature of the base plate, according to the present invention.

FIG. 24 depicts a front view of a curvature-adjustable magnetic strut having five magnets affixed to a base plate, and four stabilizing bolts, including adjustment screws extended to adjust a curvature value of the base plate, according to the present invention.

FIG. 25 is a top, side, and rear view of a curvature-adjustable magnetic strut having five magnets fixed to a base plate, and stabilizing bolts, pursuant to the present invention.

FIG. 26 depicts a front exploded view of a curvature-adjustable magnetic strut having five magnets affixed to a base plate, further including four stabilizing bolts therein.

FIG. 27 is a side elevational view of a curvature-adjustable magnetic strut having a securing plate and two hinged brackets attached to two base plates, wherein curvature is adjusted by rotating two hinges to align the two base plates, each having two magnets.

FIG. 28 is a bottom view of a curvature-adjustable magnetic strut having a securing plate and two hinged brackets attached to two base plates, wherein curvature is adjusted by rotating two hinges to align two base plates, wherein each base plate has two magnets.

FIG. 29 depicts a top plan view of a curvature-adjustable magnetic strut having a securing plate and two hinged brackets attached to two base plates, wherein curvature is adjusted by rotating the two hinges to align the two base plates, each having two magnets.

FIG. 30 depicts a front view of a curvature-adjustable magnetic strut having a securing plate and two hinged brackets attached to two base plates, wherein curvature is adjusted by rotating the two hinges to align the two base plates, each having two magnets.

FIG. 31 depicts a rear view of a curvature-adjustable magnetic strut having a securing plate and two hinged brackets attached to two base plates, wherein curvature is adjusted by rotating the two hinges to align the two base plates, each having two magnets.

FIG. 32 is a top, side, and front perspective view of a curvature adjustable magnetic strut having a securing plate and hinged brackets attached to base plates, wherein curvature is adjusted by rotating hinges to align the base plates, each with two magnets.

FIG. 33 depicts a bottom, side, and front view of a curvature-adjustable magnetic strut having a securing plate and two hinged brackets attached to base plates, wherein curvature is adjusted by rotating hinges to align the base plates, each with two magnets.

FIG. 34 depicts a top, side, and rear view of a curvature-adjustable magnetic strut having a securing plate and hinged brackets attached to base plates, wherein curvature is adjusted by rotating hinges to align base plates, each base plate having two magnets.

FIG. 35 is a top, side, and rear view of a curvature-adjustable strut having a securing plate and hinged brackets attached to base plates, wherein curvature is adjusted by rotating two hinges to align two base plates, wherein each base plate has two magnets, wherein a pipe, conduit, or tubing is shown securely mounted to the strut with a clamp.

FIG. 36 depicts a rear view of a curvature-adjustable magnetic strut having a securing plate and two hinged brackets attached to two base plates, wherein curvature is adjusted by rotating the two hinges to align the two base plates, each having two magnets, including a pipe, conduit, or tubing, as shown, securely mounted to the strut with a clamp.

FIG. 37 depicts a top, side, and front view of a curvature-adjustable magnetic strut having a securing plate and hinged brackets attached to base plates, wherein curvature is adjusted by rotating the hinges to align the two base plates, each having two magnets, including a pipe, conduit, or tubing, as shown, securely mounted to the strut with a clamp.

FIG. 38 depicts a top, side, and front view of a curvature-adjustable magnetic strut having a securing plate and hinged brackets attached to base plates, wherein curvature is adjusted by rotating the hinges to align the base plates, each base plate having two magnets, including a pipe, conduit, or tubing securely mounted to the strut with a clamp.

FIG. 39 is a side elevational view of a curvature-adjustable magnetic strut having four securing plates and four hinged brackets, with single-hinged and double-hinged bracket assemblies attached to four base plates, wherein curvature is adjusted by rotating the four hinges to align the four base plates, wherein each base plate has two magnets.

FIG. 40 depicts a top plan view of a curvature-adjustable magnetic strut having four securing plates and four hinged brackets, with single-hinged and double-hinged bracket assemblies attached to four base plates, wherein curvature is adjusted by rotation of the four hinges to align the four base plates, with each base plate having two magnets.

FIG. 41 depicts a bottom, side, and front perspective view of a curvature-adjustable magnetic strut having four securing plates and four hinged brackets, with single-hinged and double-hinged bracket assemblies attached to four base plates, wherein curvature is adjusted by rotating hinges to align the base plates, each base plate having two magnets.

FIG. 42 depicts a top, side, and front view of a curvature-adjustable magnetic strut having four securing plates and four hinged brackets, with single hinged and double hinged bracket assemblies attached to four base plates, wherein curvature is adjusted by rotating the hinges to align the four base plates, with each base plate having two magnets.

FIG. 43 depicts a front view of a curvature-adjustable magnetic strut having four securing plates and four hinged brackets, with single hinged and double hinged bracket assemblies attached to four base plates, wherein the curvature is adjusted by rotation of the four hinges to align the four base plates, with each base plate having two magnets.

FIG. 44 depicts a rear view of a curvature-adjustable magnetic strut having four securing plates and four hinged brackets, with single-hinged and double-hinged bracket assemblies attached to base plates, wherein curvature is adjusted by rotating hinges to align base plates, showing a base plate with two magnets and brackets varying in length.

FIG. 45 is a bottom view of a curvature-adjustable magnetic strut having four securing plates and hinged brackets, wherein single-hinged and double-hinged bracket assemblies attach to base plates and curvature is adjusted by rotating hinges to align base plates, wherein a base plate has two magnets and shows a strut may vary in length.

FIG. 46 depicts a front view of a curvature-adjustable magnetic strut having four securing plates and hinged brackets, wherein single-hinged and double-hinged bracket assemblies attach to four base plates, wherein a curvature value is adjusted by rotating the four hinges to align the base plates, and wherein each base plate has two magnets.

FIG. 47 is a bottom, side, and front perspective view of a curvature-adjustable magnetic strut having four securing plates and four hinged brackets, with single-hinged and double-hinged bracket assemblies attached to base plates, wherein curvature is adjusted by rotating hinges to align base plates, with each base plate having two magnets.

FIG. 48 depicts a top plan view of a curvature adjustable magnetic strut having two strut base plates securing two hinged brackets, with one on each end of the strut, wherein the hinged brackets each have a base plate, and two magnets per base plate, as shown.

FIG. 49 depicts a bottom view a curvature-adjustable magnetic strut having two strut base plates securing two hinged brackets, with one on each end of the strut, wherein the hinged brackets each have a base plate, and two magnets per base plate, as shown.

FIG. 50 depicts a side elevational view of a curvature-adjustable magnetic strut having two strut base plates securing two hinged brackets, with one on each end of the strut, wherein hinged brackets each have a base plate, and two magnets per base plate.

FIG. 51 depicts a front view of a curvature-adjustable magnetic strut having two strut base plates securing two hinged brackets, with one on each end of the strut, wherein the two hinged brackets each have a base plate, including two magnets per base plate.

FIG. 52 depicts a rear view of a curvature-adjustable magnetic strut that includes two strut base plates securing two hinged brackets, with one on each end of the strut, wherein each of the two hinged brackets has a base plate including one or more magnets.

FIG. 53 depicts a bottom, a side, and a front perspective view of a curvature-adjustable magnetic strut that includes two strut base plates securing two hinged brackets, with one on each end of the strut, wherein each of the two hinged brackets has a base plate including one or more magnets, or two magnets per base plate, as shown.

FIG. 54 depicts a top side, a lateral side, and a front side perspective view of a curvature-adjustable magnetic strut having two strut base plates securing two hinged brackets, with one on each end of the strut, wherein each of the two hinged brackets has a base plate including one or more magnets, or two magnets per base plate, as shown.

FIG. 55 depicts a top side, a lateral side, and a front side perspective view of a curvature-adjustable magnetic strut having two strut base plates securing two hinged brackets, with one on each end of the strut, wherein each of the two hinged brackets has a base plate including one or more magnets, or two magnets per base plate, as shown.

FIG. 56 depicts a bottom, a side, and a front perspective view of a curvature-adjustable magnetic strut that includes two strut base plates securing two hinged brackets, with one on each end of the strut, wherein each of the two hinged brackets has a base plate including one or more magnets, or two magnets per base plate, as shown.

FIG. 57 depicts a top side, lateral side, and a front side perspective view of a curvature-adjustable magnetic strut including two strut base plates securing two hinged brackets, with one on each end of the strut, wherein each of the two hinged brackets has a base plate including one or more magnets, or two magnets per base plate, as shown.

FIG. 58 depicts a bottom, a side, and a front perspective exploded view of a curvature-adjustable magnetic strut including two strut base plates securing two hinged brackets, with one on each end of the strut, wherein each of the hinged brackets has a base plate including one or more magnets, or two magnets per base plate, as shown.

FIG. 59 depicts a top side, a lateral side, and a front side perspective exploded view of a curvature-adjustable magnetic strut, with two strut base plates securing two hinged brackets, with one on each end of the strut, where the hinged brackets each have a base plate including one or more magnets, or two magnets per base plate, as shown.

### DETAILED DESCRIPTION OF THE PREFERRED EMBODIMENTS

While embodiments of the present Curvature-Adjustable Magnetic Strut 10A, 10B, 10C, 10D, 10E, 10F, and 10G of the present subject matter are disclosed herein, it is to be understood that the illustrated embodiments are merely exemplary of the design that may be embodied in a variety of other forms. Therefore, specific functional and structural details disclosed herein are not to be interpreted as limiting, but merely as basic for the claims and as a representative basis for teaching one skilled in the art to variously employ the present design in virtually any appropriately detailed structure as well as combination.

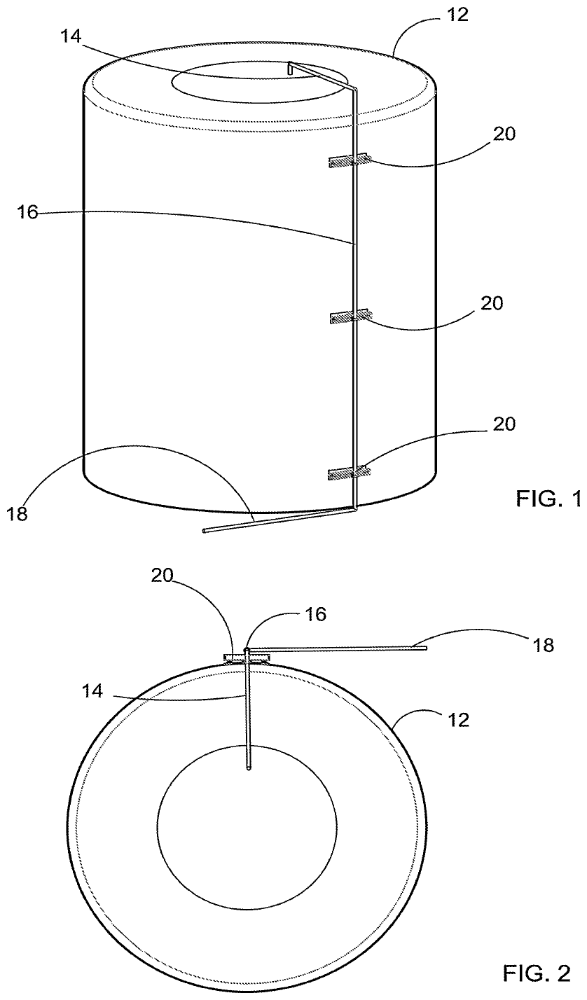

Referring now to FIG. 1, a top, side and front perspective view of a vertical liquid storage tank 12 is depicted, having a fill pipe upper portion 14, middle portion 16 and lower or ground portion 18 attached to the outer surface using three curvature-adjustable magnetic strut assemblies 20 installed to secure the fill pipe to the tank, according to the present invention. Three curvature-adjustable magnetic strut assemblies 20 are optimally located and evenly spaced apart at the lower portion of the pipe 18, middle portion of the pipe 16 and upper portion of the fill pipe 14. Each of the three curvature-adjustable magnetic strut assemblies 20 have been curvature adjusted to conform closely to the curvature of the fuel tank 12. Three curvature-adjustable magnetic strut assemblies 20 are secured to the outer surface of the fuel tank 12 by magnets located on the lower side of the curvature-adjustable magnetic strut assemblies 20 (see below). By using magnets to secure the curvature-adjustable magnetic strut assemblies 20, the pipe supporting structure can be installed without the need for welding or tools other than a socket wrench.

In this way, pipe supporting struts can be quickly, easily and securely installed on any existing fuel tank with a magnetic surface, and installed in any number of units and spacings, including installations on both curved tank surfaces and flat tank surfaces.

FIG. 2 depicts a top plan view of a vertical liquid storage tank 12 having a fill pipe 14, 16, and 18 attached to an outer surface of a vertical liquid storage tank 12 using three (with only one fill pipe being visible in the top plan view) curvature-adjustable magnetic strut assemblies 20 to secure the fill pipe upper portion, middle portion, and lower portion to the vertical liquid storage tank 12, as shown in FIG. 1, according to the present subject matter. It is anticipated that the fuel or gas storage tank may also be in a horizontal configuration, such as a common propane storage tank, and that the same curvature-adjustable magnetic strut assemblies 20 may be used to support such pipe, conduit, and tubing thereto in a similar fashion. For horizontally configured tanks, since the curvature is vertically oriented, then curvature-adjustable magnetic strut assemblies 20 would be installed at a 90-degree angle to those shown installed in FIG. 1, also shown in FIG. 2.

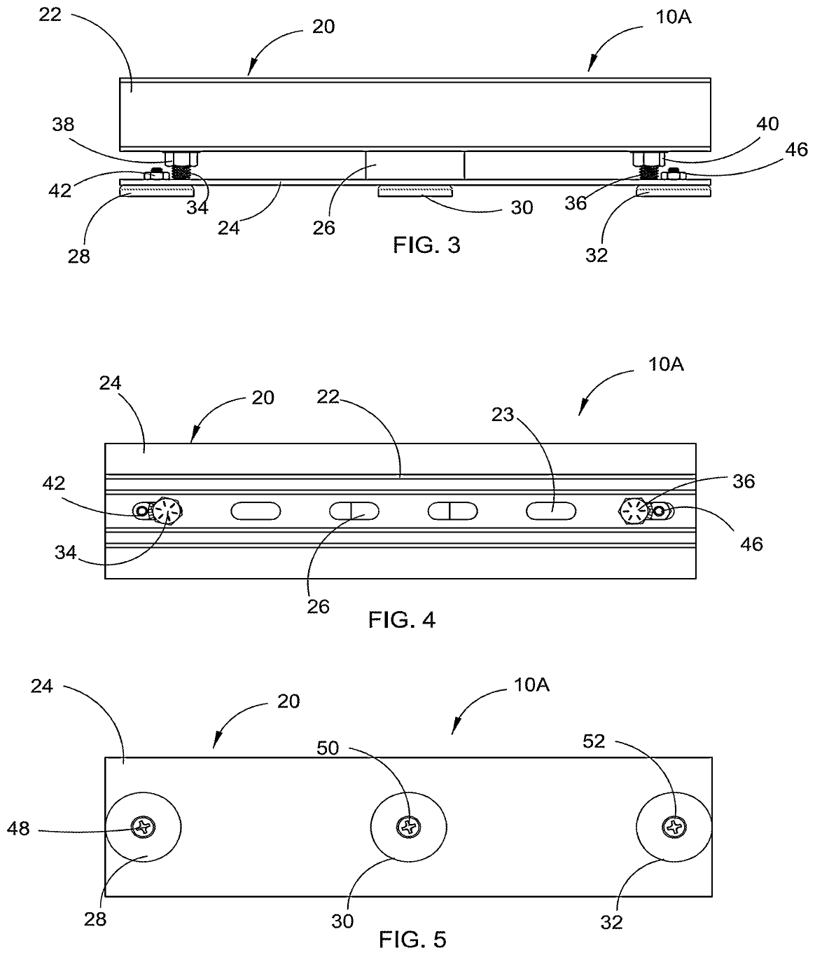

FIG. 3 depicts a side elevational view of an embodiment of a curvature-adjustable magnetic strut 10A assembly 20 having a configuration of three magnets affixed to the base plate, according to the present subject matter. The strut channel 22 can be any of the UNISTRUT® Models, including but not limited to, Models P1000, P1100, P3000, P3300, P4000, P4100, PS000 and P5500. Additionally, it is anticipated that the strut channel may be slotted in various slot configurations. The preferred embodiments all use slotted strut channel, and the preferred strut used here is UNISTRUT® Model is P1000 slotted channel. The strut 22 is bolted, screwed, or welded to a middle block 26 which is secured to the magnet base plate 24. The magnetic base plate 24 includes three magnets 28, 30 and 32 affixed to the underside of the magnetic base plate 24. Curvature adjustment bolts 34 and 36 and nuts 38 and 40 (the bolt heads are not visible here, see below) are mounted through a slot 23 (see below) in the slotted strut channel 22 and contact the magnet base plate 24. The magnets 28, and 32 are secured to the magnet base plate using magnet retaining screws having screw nuts 42 and 46 visible as shown.

FIG. 4 depicts a top plan view of a curvature-adjustable magnetic strut embodiment 10A assembly 20 having three magnets affixed to the base plate, according to the present invention. Here is shown the slotted strut channel 22 with slot 23 and the curvature adjustment bolts 34 and 36, here showing the bolt heads. Also seen here through the slots in the slotted strut channel are the magnet retaining screw nuts 42 and 46 as well as the middle connection block 26 seen through slots 23 in the slotted strut channel 22.

FIG. 5 depicts a bottom view of a curvature-adjustable magnetic strut embodiment 10A assembly 20 having three magnets affixed to a base plate. The three magnets 28, 30 and 32 are fastened to the magnet base plate 24 using magnet retaining screws 48, 50 and 52, respectively. Corresponding magnet retaining nuts are not visible in this view.

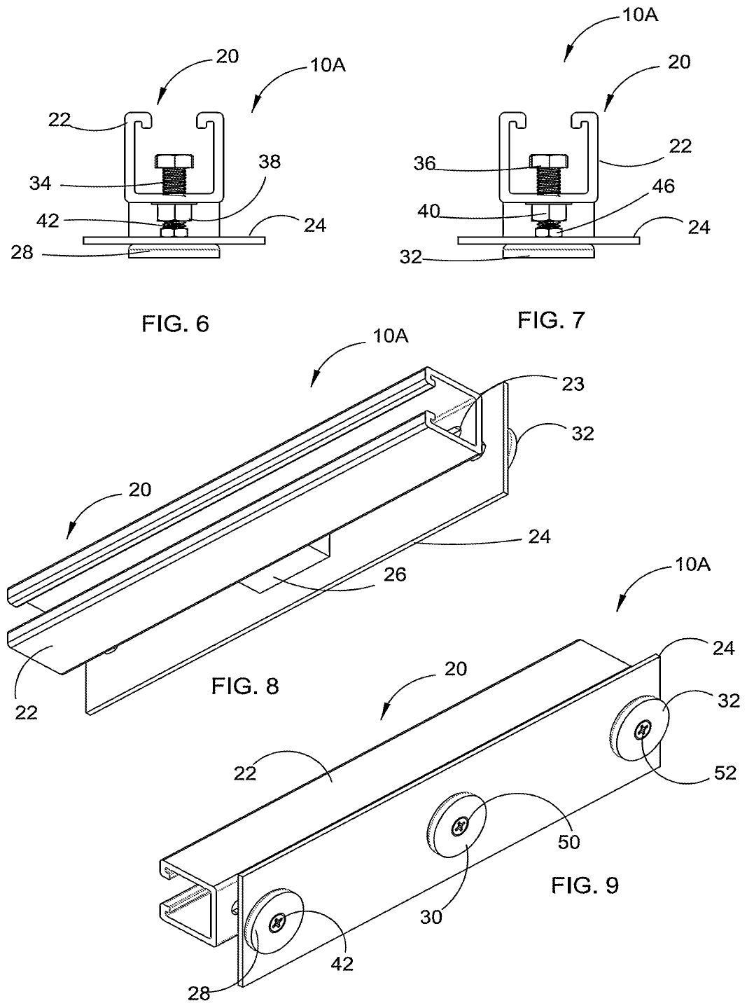

FIG. 6 depicts a front view of a curvature-adjustable magnetic strut embodiment 10A assembly 20 with three magnets affixed to a base plate. The FIG. 6 front view better illustrates the structure of the curvature adjustment bolt 34 and corresponding curvature adjustment nut 38. When curvature adjustment is required, the curvature adjustment bolt 34 is rotated and the bolt 34 presses against magnet base plate 24, causing the magnet base plate 24 to curve, and the more the curvature adjustment bolt 34 is tightened down, the more the magnet base plate 24 curves to accommodate the curvature of a fuel tank 12 outer surface. In this way, the optimum surface area of the magnet to tank 12 surface is achieved, to securely fasten the strut assembly 20 to an outer surface of a storage tank.

FIG. 7 depicts a rear view of a curvature-adjustable magnetic strut embodiment 10A assembly 20 having three magnets affixed to the base plate, according to the present subject matter. This FIG. 7 rear view better illustrates the structure of the opposite curvature adjustment bolt 36 and corresponding curvature adjustment nut 40. When curvature adjustment is required, the curvature adjustment bolt 36 is rotated and the bolt 36 presses against the magnet base plate 24 and causes the magnet base plate 24 to curve, the more the curvature adjustment bolt 34 is tightened down, the more the magnet base plate 24 curves to accommodate the curvature of a fuel tank outer surface thereof. To reverse such a curvature adjustment, the curvature adjustment 36 bolt is reverse rotated to apply less pressure, and thereby less curvature, to the magnet base plate 24.

FIG. 8 depicts a top view, a sideview, and a rear perspective view of a curvature-adjustable magnetic strut embodiment 10A assembly 20 having three magnets affixed to a base plate, according to the present subject matter. Here is illustrated the middle connection block 26 spanning the slotted strut channel 22 and the magnet base plate 24.

FIG. 9 presents a bottom view, a side view, and a front perspective view of a curvature-adjustable magnetic strut embodiment 10A assembly 20 equipped with three magnets affixed to the base plate, in accordance with the present subject matter. This view clearly shows the positioning of the three magnets 28, 30, and 32 being held in place on the magnet base plate 24 using magnet retaining screws 42, 50, and 52, respectively.

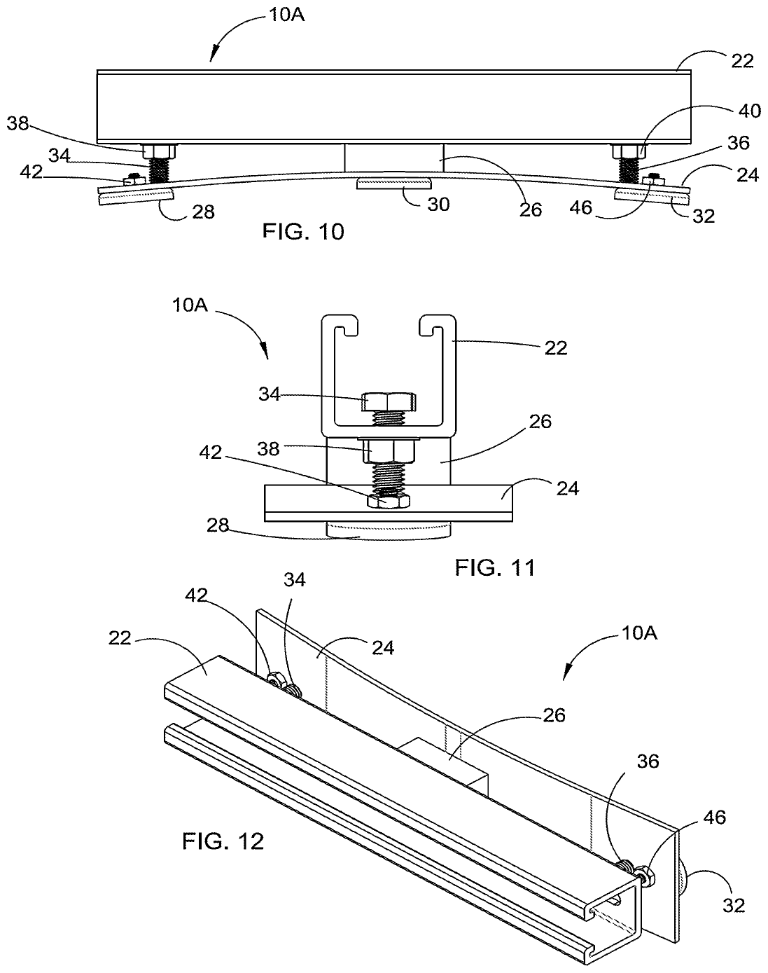

FIG. 10 depicts a side elevational view of a curvature-adjustable magnetic strut embodiment 10A assembly 20 having three magnets 28, 30, and 32 affixed to the magnet base plate 24, wherein the curvature adjustment bolts 34 and 36 on each end have been extended to adjust the curvature of the magnet base plate 24, according to the present subject matter. In this way, said assembly 20 can be curvature adjusted on the magnet base plate 24 to closely parallel the curved surface of a tank 12, for making the magnetic attachment of said assembly 20 optimally strong against the outer surface of the tank 12.

FIG. 11 depicts a front view of a curvature-adjustable magnetic strut embodiment 10A assembly 20 with three magnets 28, 30, and 32 affixed to the base plate 24, wherein the curvature adjustment bolts 34 and 36 have been extended to adjust the curvature of the base plate, according to the present subject matter. FIG. 11, a front view, better illustrates structure of the curvature adjustment bolt 34 and its corresponding curvature adjustment nut 38 when extended out against magnet base plate 24. When curvature adjustment is required, curvature adjustment bolt 34 is rotated and the bolt 34 presses against magnet base plate 24, causing magnet base plate 24 to curve; and the more curvature adjustment bolt 34 is tightened down, the more magnet base plate 24 curves to accommodate curvature of a fuel tank 12 outer surface. In this way, the magnets 28, 30, and 32 lay flat on the tank surface and the optimum surface area of the magnets to tank 12 surface is achieved to securely fasten assembly 20 to the outer surface of a tank.

FIG. 12 presents a top view, a side view, and a front perspective view of a curvature-adjustable magnetic strut embodiment 10A assembly 20 having three magnets 28, 30, and 32 affixed to base plate 24, wherein the curvature adjustment bolts 34 and 36 have been extended to adjust a curvature value for the base plate 24, in accordance with the present subject matter. Also presented in FIG. 12 is the middle connection block 26.

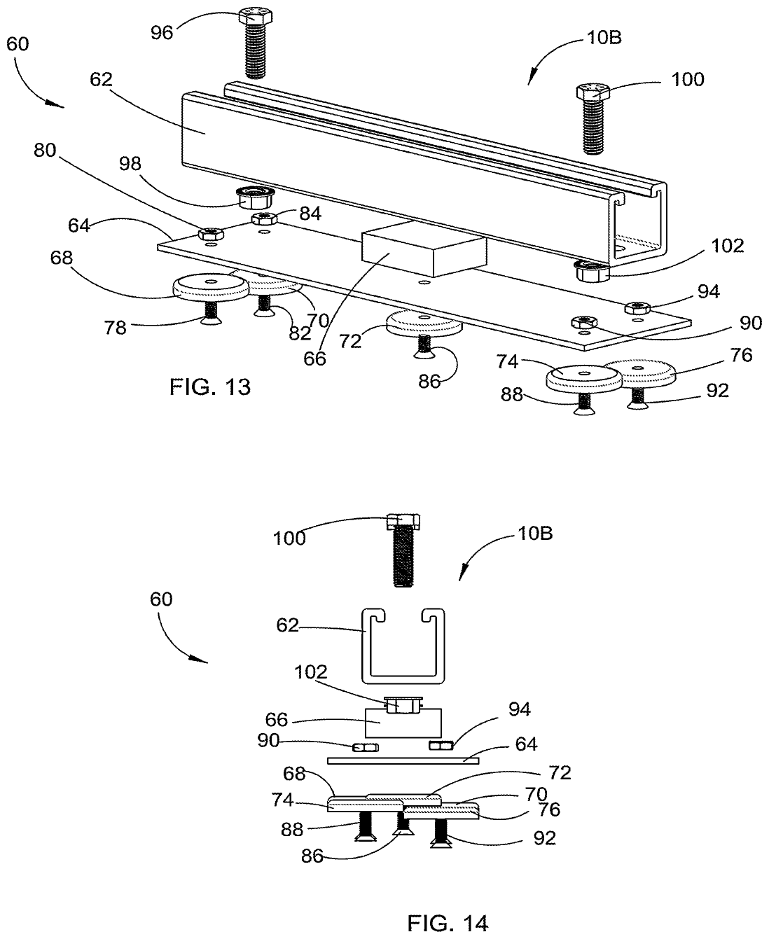

FIG. 13 presents a top view, a sideview, and a front perspective (and exploded) view of another curvature-adjustable magnetic strut embodiment 10B assembly 60 of the present subject matter. Assembly 60 has five magnets affixed to a base plate. A slotted strut channel 62 is fastened to a middle connection block 66 secured to a magnet base plate 64 having five magnets 68, 70, 72, 74, and 76 affixed by magnet retaining screws 78, 82, 86, 88, and 92 including corresponding magnet retaining nuts 80, 84, 90, and 94. Curvature adjustment bolts 96, 100 have associated curvature adjustment nuts 98, 102.

FIG. 14 depicts a front exploded view of another curvature-adjustable magnetic strut embodiment 10B assembly 60 having five magnets 68, 70, 72, 74 and 76 affixed to the base plate 64. This FIG. 14 better illustrates the assembly 60 showing the curvature adjustment bolt 100 and nut 102 as it would pass through the end slot in the slotted strut channel 62. Also shown in FIG. 14 is the position of the middle connection block 66 in relation to the magnet base plate 64. Magnets 70, 72, and 74 are shown in relation to magnet retaining screws 86, 88, and 92 and associated magnet retaining nuts 90 and 94.

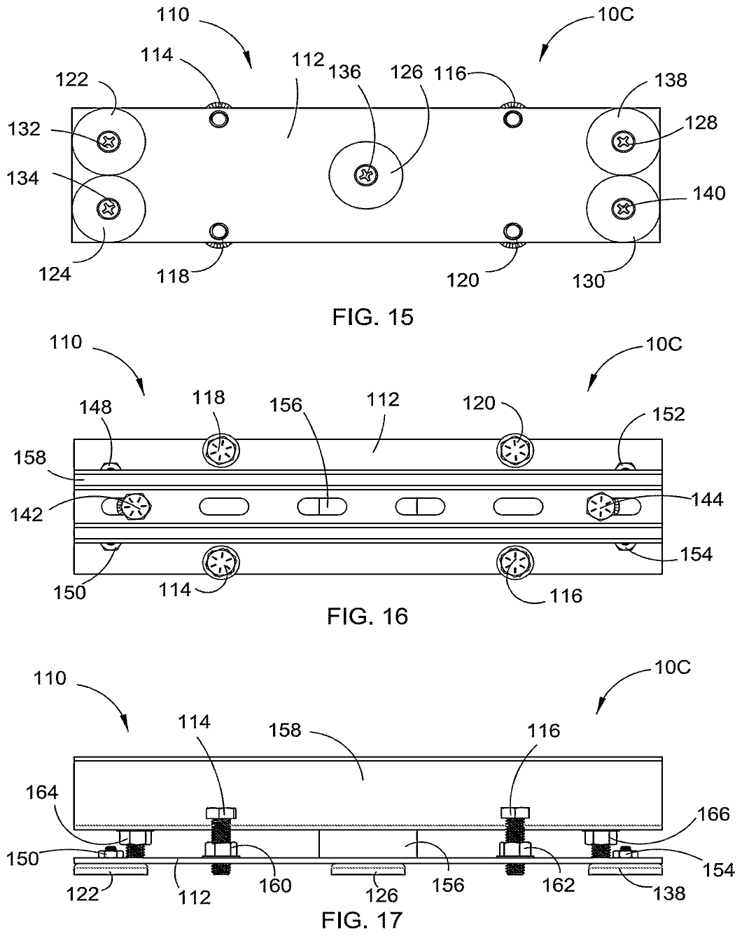

FIG. 15 presents a bottom view of another curvature-adjustable magnetic strut embodiment 10C assembly 110 in accordance with the present subject matter. Assembly 110 includes five magnets 122, 124, 126, 128, and 130 affixed to a magnet base plate 112. Assembly 110 also includes four stabilizing bolts 114, 116, 118 and 120. Each of the five magnets 122, 124, 126, 128, and 130 are secured to the magnet base plate 112 using a respective one of a plurality of magnet retaining screws 132, 134, 136, 138 and 140.

FIG. 16 is a top plan view of the curvature-adjustable magnetic strut embodiment 10C assembly 110 having five magnets (not visible in this view) affixed to magnet base plate 112, including four stabilizing bolts 114, 116, 118, and 120. FIG. 16 depicts slotted strut channel 158, middle connection block 156 spanning slotted strut channel 158, and magnet base plate 112. Also seen are two curvature adjustment bolts 142, 144 at each end of slotted strut channel 158. Partially seen are retaining nuts 148, 150, 152 and 154.

FIG. 17 depicts a side elevational view of the curvature-adjustable magnetic strut Embodiment 10C assembly 110 having five magnets with 122, 126 and 138 shown, affixed to the magnet base plate 112, and including four stabilizing bolts with 114 and 116 shown, having corresponding stabilizing nuts 160 and 162 shown here in this side view, according to the present subject matter. Also shown are curvature adjustment nuts 164 and 166, as well as magnets 122, 126, and 138 and magnet retaining nuts 150 and 154.

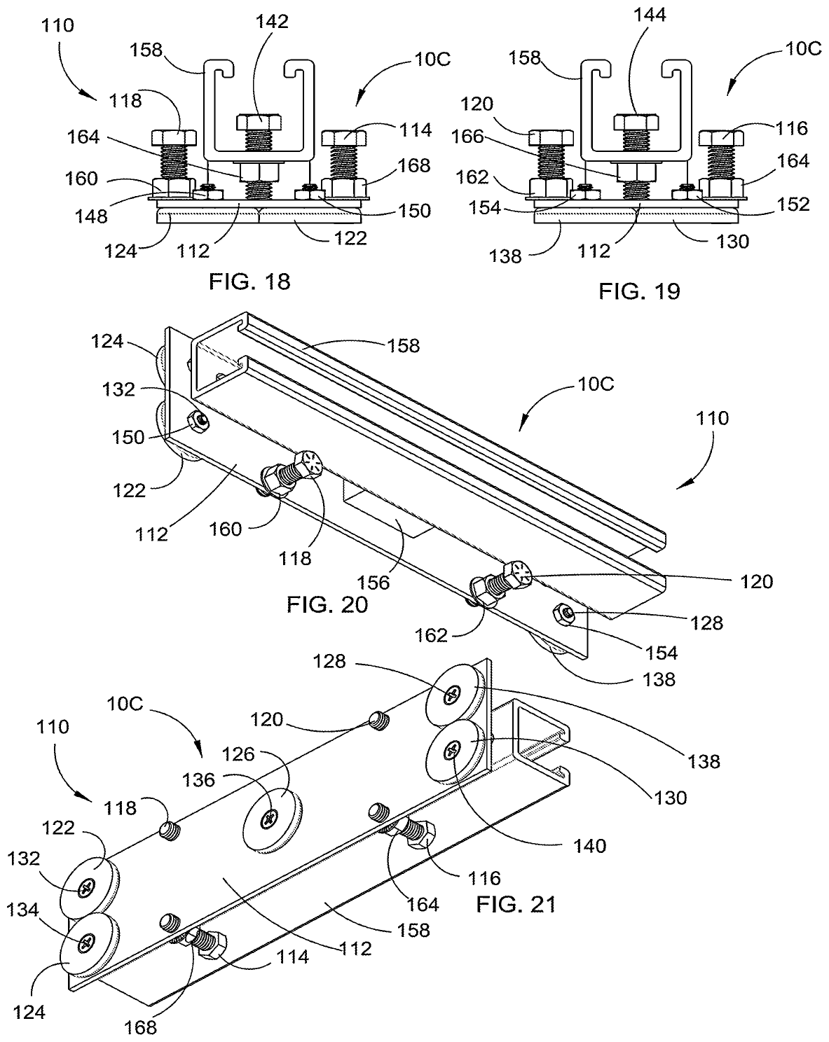

FIG. 18 depicts a front view of the curvature-adjustable magnetic strut embodiment 10C assembly 110 of the present subject matter. Assembly 110 includes five magnets (with only magnets 122, 124 being visible in FIG. 18), affixed to magnet base plate 112 using magnet retaining nuts 148 and 150, respectively, and including stabilizing bolts 114, 118 having stabilizing nuts 168 and 160 thereon, according to the present subject matter. Also seen in FIG. 18 is curvature adjustment bolt 142 and curvature adjustment nut 164.

FIG. 19 depicts a rear view of the curvature-adjustable magnetic strut embodiment 10C assembly 110 having five magnets affixed to a base plate and including stabilizing bolts. FIG. 19, an opposite end view of FIG. 18, presents magnets 130 and 138 affixed to magnet base plate 112 using magnet retaining nuts 152 and 154, respectively, and including stabilizing bolts 116 and 120 having associated stabilizing nuts 164 and 162 thereon, according to the present subject matter. Also seen in FIG. 19 is curvature adjustment bolt 144 including an associated curvature adjustment nut 166. As shown in FIG. 19, magnet base plate 112 remains flat as the curvature adjustment bolts 142 and 144 have not been tightened down to adjust the curvature of the magnet base plate 112.

FIG. 20 depicts a top view, a side view, and a front perspective view of the curvature-adjustable magnetic strut embodiment toe assembly 110 of the present subject matter. Assembly 110 has five magnets affixed to a base plate. In FIG. 20, only three magnets 122, 124, and 138 are shown. Assembly 110 includes stabilizing bolts 118 and 120 having stabilizing nuts 160 and 162 therein. FIG. 20 depicts a relationship between slotted strut channel 158, middle connection block 156, and the magnet base plate 112.

FIG. 21 depicts a bottom view, a side view, and a rear perspective view of the curvature-adjustable magnetic strut embodiment toe assembly 110 including five magnets 122, 124, 126, 130, and 138 affixed to the base plate 112 using magnet retaining screws 132, 134, 136, 128, and 140, respectively, and including four stabilizing bolts 114, 116, 118, and 120 therein, with only two bolts 114, 116 visible, with each having a stabilizing nut 168 and 164, affixed to base plate 112, in accordance with the present subject matter.

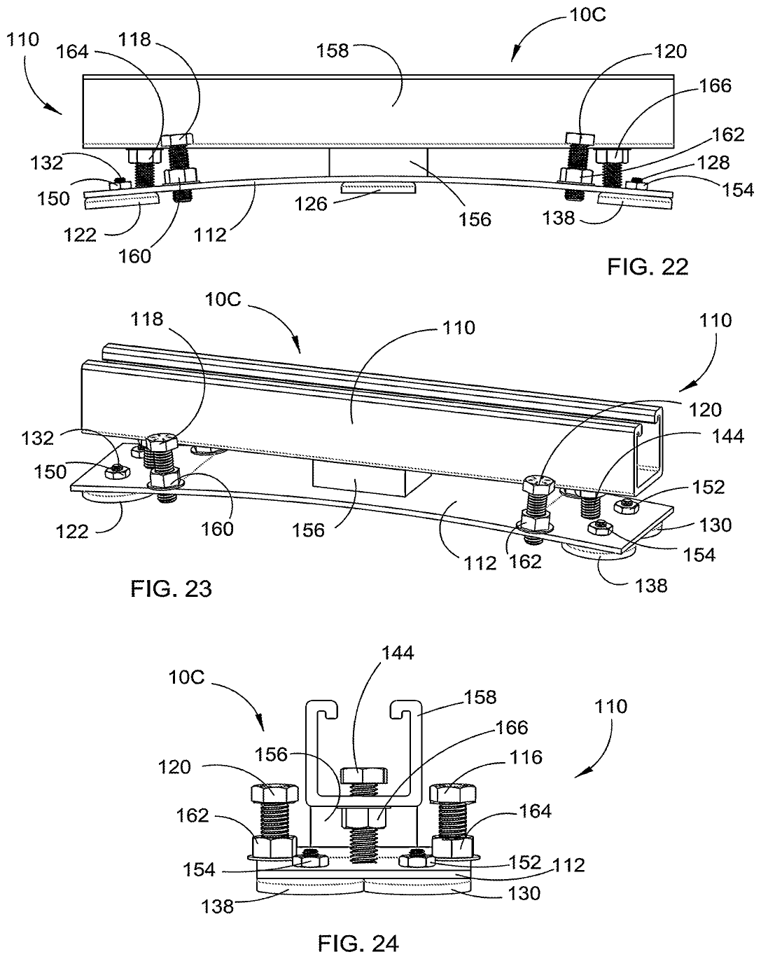

FIG. 22 is a side elevational view of curvature-adjustable magnetic strut embodiment 10C assembly 110 having five magnets, with three magnets 122, 126, and 138 shown, including curvature adjustment bolts 142 and 144 (not visible) extended to adjust the curvature of base plate 112, according to the present subject matter. When the curvature adjustment bolts are rotated, they tighten down and press against magnet base plate 112 causing it to curve variably. Curvature adjustment nuts 164 and 166 are shown. Also shown are stabilization bolts 118 and 120 as well as corresponding stabilization nuts 160 and 162. In operation, after the curvature of the magnet base plate 112 is adjusted, the stabilizing bolts 118 and 120 are rotated in a manner to contact a surface (not shown) of the tank 12 to significantly stabilize the attachment of the assembly 110 to the tank 12.

FIG. 23 depicts a top view, a side view, and a rear perspective view of the curvature-adjustable magnetic strut embodiment 10C assembly 110 having five magnets (with only 122, 130, and 138 shown) fixed to base plate 112, including four stabilizing bolts (with only bolts 118 and 120 shown in FIG. 23), with the curvature adjustment bolts 142 and 144 (and only bolt 144 shown) extended to adjust the curvature of the base plate 112, according to the present subject matter. The pressure of the curvature adjustment bolts 142 and 144 bearing down on the magnet base plate 112 causes the magnet base plate to bend and variably curve, to closely parallel the curved surface of a vertical or horizontal cylindrical storage tank. In this way, piping, conduit, and tubing can be quickly installed on virtually any curved surface of a vertical or horizontal cylindrical storage tank.

FIG. 24 depicts a front view of the curvature-adjustable magnetic strut embodiment 10C assembly 110 having five magnets (with only 130 and 138 shown) affixed to base plate 112 and including four stabilizing bolts (with only 116, 120 being shown in FIG. 24), in accordance with the present subject matter. In FIG. 24, curvature adjustment bolt 144 has been rotated and tightened down to apply pressure to magnet base plate 112. Such downward rotation of the curvature adjustment bolt 144 becomes evident when compared to its position in FIG. 19. In operation, applied pressure causes the magnet base plate 112 to curve variably, depending on the extent of the rotation of the curvature adjustment bolt 144 and the consequent downward movement, allowing for a curvature adjustment of the assembly 110, for securely attaching to a curved surface of a fuel tank or the like.

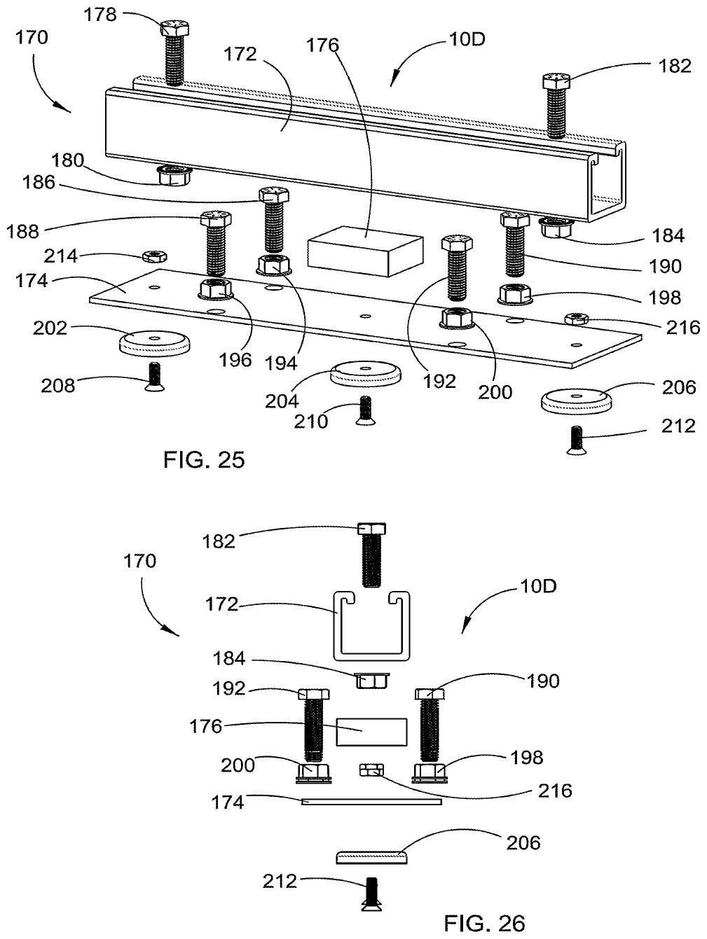

FIG. 25 depicts a top, side and front exploded view of another curvature-adjustable magnetic strut embodiment 10D assembly 170 having three magnets 202, 204 and 206 with four stabilizing bolts 186, 188, 190 and 192 with corresponding stabilizing nuts 194, 196, 198, and 200. FIG. 25 depicts a relationship between the slotted strut channel 172, the middle connection block 176, and the magnet base plate 174. FIG. 25 also depicts the curvature adjustment bolts 178, 182 including their associated curvature adjustment nuts 180, 184. Also, magnets 202 and 206 are secured to the magnet base plate 174 using magnet retaining screws 208, 212 by means of their associated magnet retaining nuts 214, 216. Curvature-adjustable magnetic strut embodiment 10D assembly 170 of the present subject matter includes three magnets 202, 204, and 206 including four stabilizing bolts 186, 188, 190, and 192, depicting the possibility that an assembly may include 3-5 magnets and 0 or 4 stabilizing bolts, as illustrated by embodiments 10A, 10B, and 10C.

FIG. 26 depicts a front exploded view of the curvature-adjustable magnetic strut embodiment 10D assembly 170 of the present subject matter. Assembly 170 includes three magnets (with only magnet 206 shown) affixed to the base plate 174 and including four stabilizing bolts therein (with only bolts 190 and 192 shown). Curvature adjustment bolt 182 passes through a slot in slotted strut channel 172 and is secured by curvature adjustment nut 184. Also shown in this exploded view, are two of the four stabilizing bolts 190 and 192, with corresponding stabilizing nuts 198 and 200. The stabilizing bolts pass through orifices in the magnet base plate 174 and then are tightened down to contact the tank surface to optimally stabilize the assembly when installed on the curved tank surface.

In summary, curvature-adjustable magnetic strut assemblies 10A, 10B, 10C, and 10D of the present subject matter, constructed from a minimal number of components, include, e.g., the following: 1) a nominal 12-inch to nominal 24-inch piece of slotted strut channel; 2) a nominal 1.5-inch by nominal 2-inch by nominal ½-inch rectangular piece of iron or carbon steel flat bar welded to a back side of a Unistrut along the center thereof. Next, welded to such flat iron bar is a nominal 12-inch by nominal ⅛-inch piece of flat iron parallel to the Unistrut with a nominal ½-inch gap between them. To the back side are three, four, five, or optionally up to six magnets fixed to the Unistrut. Approximately 2 inches from the ends thereof, adjustment bolts will run through the slotted strut channel on both ends and pressing against the back piece of the iron or carbon steel flat bar. Such a curvature adjustment bolt is used to adjust the curvature of a flat iron magnet base such that the magnets thereon match in curvature to the curved surface it is being magnetically attached to, namely, the curved (or flat) fuel tank surface portion, whether that curvature be horizontal or vertical in nature. Once a desired placement is determined, a curvature-adjustable magnetic strut assembly is set in place and the adjustment bolts are tightened down against the magnetic base plate until all magnets are arranged flat against a metal surface of the tank. One can then proceed with installing pipe, conduit, tubing, etc. One advantage is that installation is achieved using no tools other than a socket wrench, eliminating a need for welding, drilling, or special tools. This saves time and money. In addition, such attachment to fuel tanks is a safer option than welding. As described in connection with FIGS. 1-26, the number of magnets may increase for heavier duty applications. Magnet shapes and sizes may be variable, including but not limited to circular, rectangular, and square magnets, and/or rare earth magnets for high temp applications. A variety of embodiments are applicable for use on curved and flat surfaces.

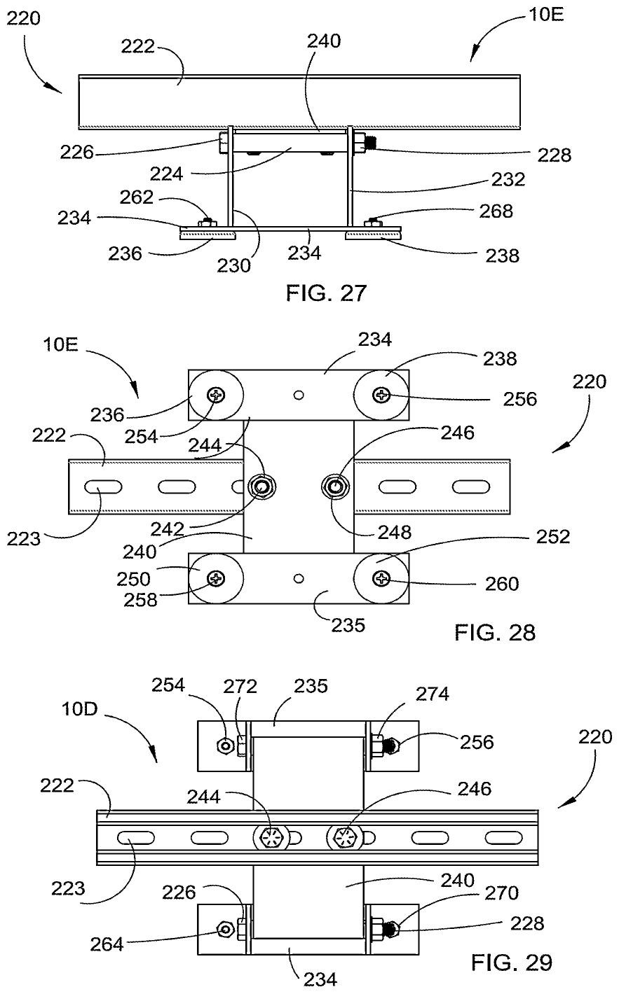

FIG. 27 depicts a side elevational view of another embodiment of a curvature-adjustable magnetic strut 10E assembly 220 having a strut channel securing plate 240 connected to the slotted strut channel 222 and spanning two single hinged bracket members (where one bracket member is shown having bracket walls 230, 232) attached to two magnet base plates (with one magnet base plate 234 shown), wherein curvature is adjusted by rotation of the two brackets about two hinges 224 as shown in FIGS. 27 to align the magnet base plates 234 and 235, each having two magnets (with only magnets 236 and 238 shown). Hinge 224 includes a hinge pin bolt 226 and a hinge pin nut 228.

FIG. 28 presents a bottom view of the curvature-adjustable magnetic strut embodiment 10E assembly 220 shown in FIG. 27. The assembly 220 includes a strut securing plate 240 having two single hinged brackets (not seen) attached to two magnet base plates 234 and 235, wherein the curvature is adjusted by rotation of the two hinges (not seen) to align the two base plates 234 and 235, each having two magnets 236, 238, 250 and 252 thereon. The strut securing plate 240 is affixed to the slotted strut channel using two securing bolts 244 and 246 (not seen, see FIG. 29) having corresponding securing bolts 244 and 246. Magnets 236, 238, 250 and 252 are held in place on the magnet base plates 234 and 235 using magnet retaining screws 254, 256, 258 and 260.

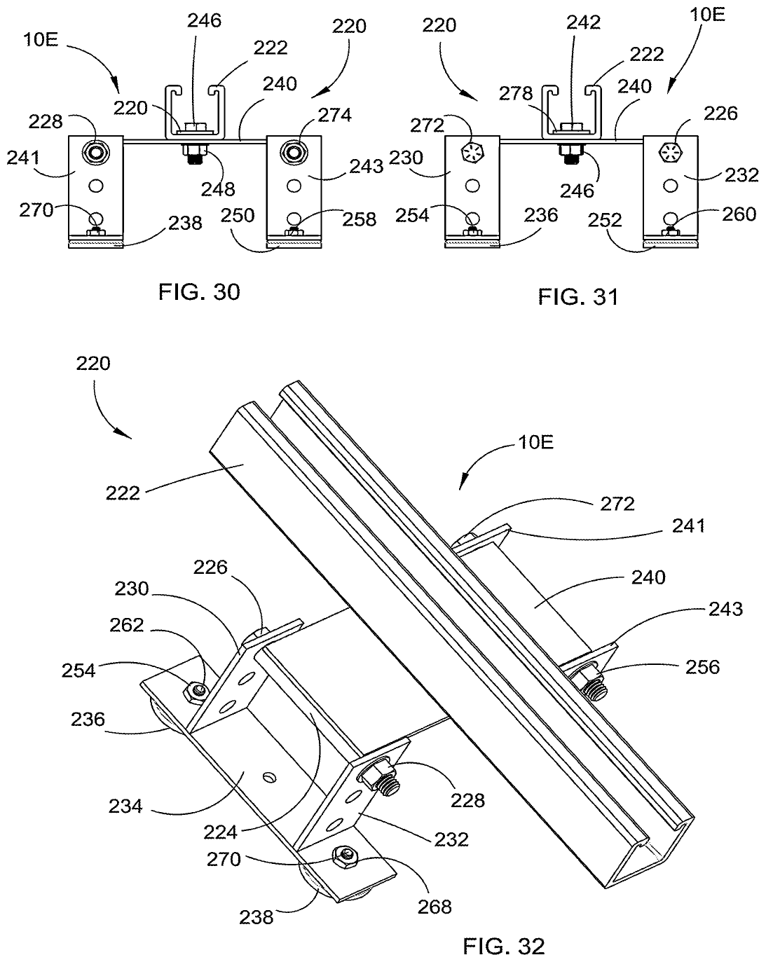

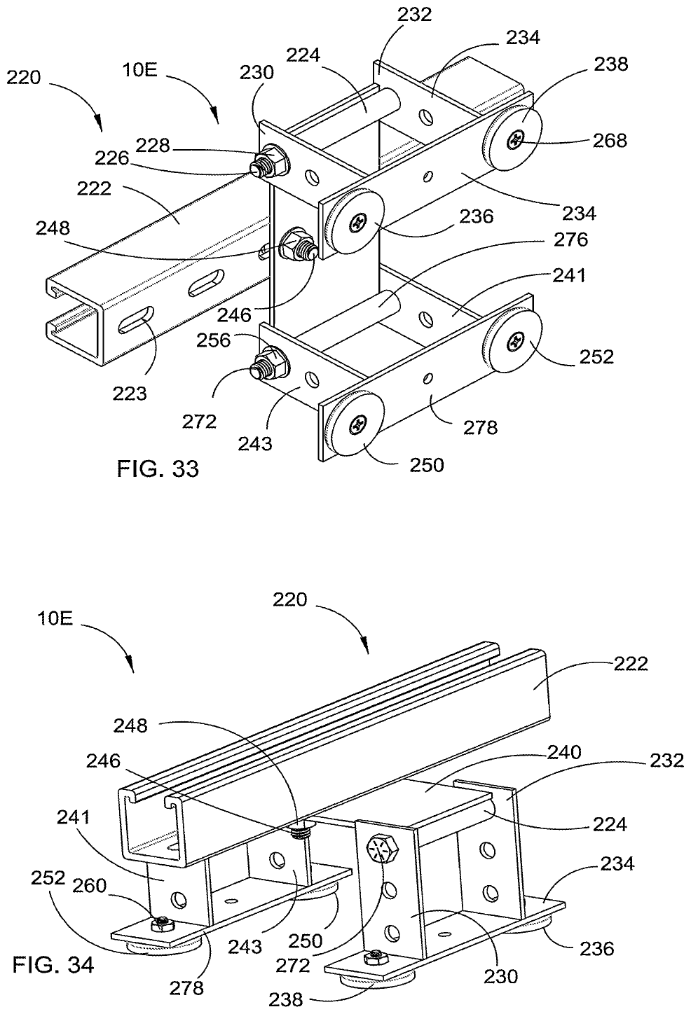

FIG. 29 depicts a top plan view of a curvature-adjustable magnetic strut embodiment 10E assembly 220 having a strut securing plate 240 having two hinged brackets (not shown in FIG. 29; please refer to FIG. 33) attached to two base plates 234 and 235, wherein a curvature value is adjusted by rotation of the two brackets about the two hinges to align the two base plates, each having two magnets. This top view clearly shows the strut securing plate 240 and the two hinges being secured by hinge pin bolts 226 and 272, including associated hinge pin nuts 228 and 274, respectively. Additionally, this top view demonstrates that the two strut securing bolts 244 and 246 each pass through a slot 223 in slotted strut channel 222 (please also refer to FIGS. 30, 31). Magnets (not seen in this view) are secured using magnet securing nuts 254, 256, 264, and 270.

FIG. 30 depicts a front view of a curvature-adjustable magnetic strut embodiment 10E assembly 220 including a strut securing plate 240 having two hinged bracket hinges (not shown in FIG. 30; please refer to FIG. 33) attached to two magnet base plates 234 and 235, wherein a preselected curvature value can be adjusted by rotation of the two bracket assemblies that have bracket walls 230, 232, 241, and 243 about two hinges 224 and 276, to align the magnet base plates 234 and 235, wherein each plate has two magnets thereon, with magnets 238 and 250, as shown in FIG. 30. Also seen are hinge pin retaining nuts 228 and 274. In this way, the magnet base plates adjust to a curvature of the surface of either a vertical or horizontal steel-constructed fuel storage tank, by rotating about each hinge until magnet base plates 234 and 235 are flush with curvature of such tank. It is also anticipated that strut securing plate 240 may have a variable length.

FIG. 31 depicts a rear view (an opposite view from FIG. 30) of a curvature-adjustable magnetic strut embodiment 10E assembly 220 having a strut securing plate 240 spanning two hinged bracket assemblies attached to two magnet base plates 234 and 235, wherein the curvature is adjusted by rotation of the two hinges to align the two magnetic base plates, each having two magnets thereon. The strut is secured to the strut securing plate 240 using strut securing bolt 242 and strut securing nut 246. Hinge pin blots 272 and 226 are visible here. Magnets 236 and 252 are secured to the magnet base plates 234 and 235 using magnet securing screws and nuts 254 and 260, respectively.

FIG. 32 depicts a top view, a side view, and a front view of a curvature-adjustable magnetic strut embodiment 10E assembly 220 including a strut securing plate 240 spanning two hinged bracket assemblies attached to two magnet base plates 234, as shown in FIG. 32 which clearly shows one of the two hinged bracket assemblies with bracket walls 230 and 232 attached to the strut securing plate 240 via a hinge 224 using a hinge pin bolt 226 and hinge pin nut 228. Magnet base plate 234 includes two magnets 236 and 238 secured using magnet retaining screws 262 and 270 as well as magnet retaining nuts 254 and 268, respectively. Additionally, in this view, bracket assembly walls 241 and 243 are seen along with the hinge retaining bolt 272 and the hinge retaining nut 256, which secure the bracket assembly to the strut securing plate 240. These two bracket assemblies rotate about the hinges, wherein the curvature is adjusted by rotation of the two hinges to align the two magnet base plates to be flush with the curvature of the tank (not shown), with each of the magnet base plates having two magnets secured thereon.

FIG. 33 depicts a bottom view, a side view, and a front view of a curvature-adjustable magnetic strut embodiment 10E assembly 220 having a strut securing plate 240 spanning two hinged bracket assemblies attached to two magnet base plates 234, shown here. FIG. 33 clearly shows each of the hinged bracket assemblies having bracket walls 230 and 232, including 241 and 243 attached to the strut securing plate 240 using hinges 224 and 276 having hinge pin bolts 226, 272 and hinge pin nuts 228, 256 being visible. Magnet base plates 234 and 235 each include two magnets each (236 and 238, and 250 and 252) secured using magnet retaining screws 268, for example. Additionally, in this view, strut securing bolt 246 and strut securing nut 248 are seen, which secure the strut 222 to strut securing plate 240 which spans the two bracket assemblies. The two bracket assemblies rotate about the hinges, wherein the curvature is adjusted by rotation of the two hinges to align the two magnet base plates to be flush with the curvature of the tank (not shown), with each of the two magnet base plates having two magnets thereon.

FIG. 34 depicts a top view, a side view, and a rear view of a curvature-adjustable magnetic strut embodiment 10E assembly 220 having a strut securing plate 240 having two hinged bracket assemblies having bracket walls 230 and 232, and 241 and 243 attached to the strut securing plate 240 using hinges 224 and 276 (with only 224 being visible in FIG. 34) having hinge pin retaining bolts 226 and 272 (with only bolt 272 being visible in FIG. 34) and hinge pin retaining nuts 228, 256 with neither visible. The hinged bracket assemblies are attached to the magnet base plates, wherein curvature is adjusted by rotation of the two hinges to align the two base plates, each plate having two magnets.

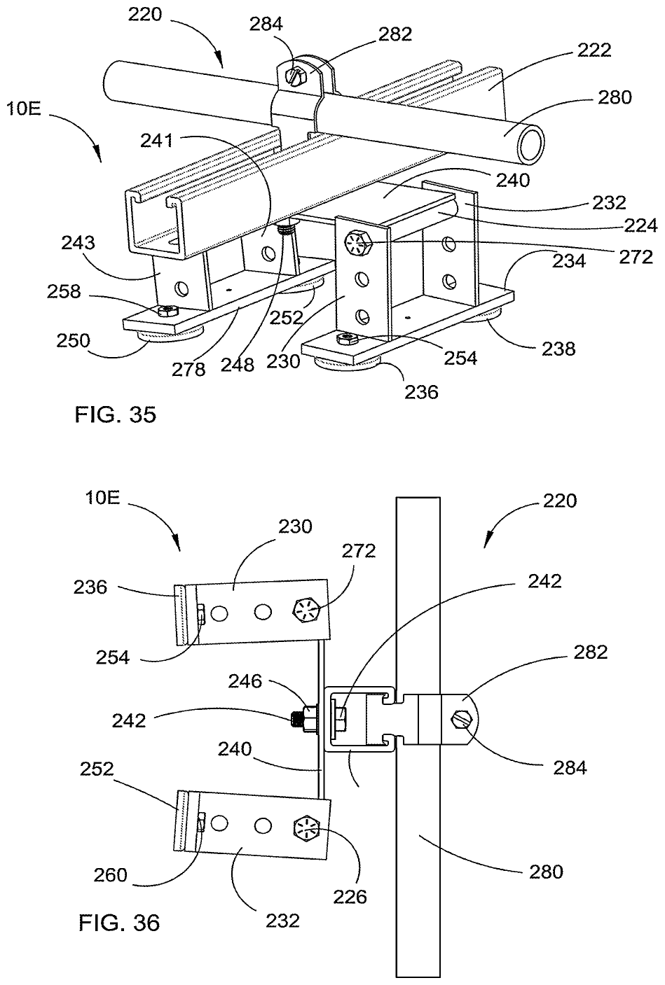

FIG. 35 depicts a top view, a side view, and a rear view of a curvature-adjustable magnetic strut embodiment 10E assembly 220 having a securing plate 240 having two hinged bracket assemblies attached to two magnet base plates 234 and 278, wherein the curvature is adjusted by rotation of the two hinges (along with hinge 224, as shown in FIG. 35) to align the two magnet base plates 234 and 278, wherein each base plate has two magnets 236 and 238 and 250 and 252 thereon. In FIG. 35, the curvature-adjustable magnetic strut embodiment 10 assembly 220 is shown in use having a pipe, a conduit or tubing 280 securely mounted to the curvature-adjustable magnetic strut embodiment 10E assembly 220 with a conventional pipe clamp 282 and clamp retaining bolt and nut 284.

FIG. 36 is a rear view of a curvature-adjustable magnetic strut embodiment 10E assembly 220 having a strut securing plate 240 with two hinged bracket assemblies attached to magnet base plates 234 and 278, wherein the curvature is adjusted by rotation of the two hinges (with hinge 224 shown here) to align the magnet base plates 234 and 278, each having two magnets 236 and 238 and 250 and 252 thereon. In FIG. 36, the curvature-adjustable magnetic strut embodiment 10E assembly 220 is shown in use having a pipe, conduit, or tubing 280 securely fixed to the curvature-adjustable magnetic strut embodiment 10E assembly 220 with a conventional pipe clamp 282 and clamp retaining bolt and nut 284. Additionally, the two hinged bracket assemblies have been rotated slight inward to conform to the curvature of a tank surface, as shown in FIG. 36.

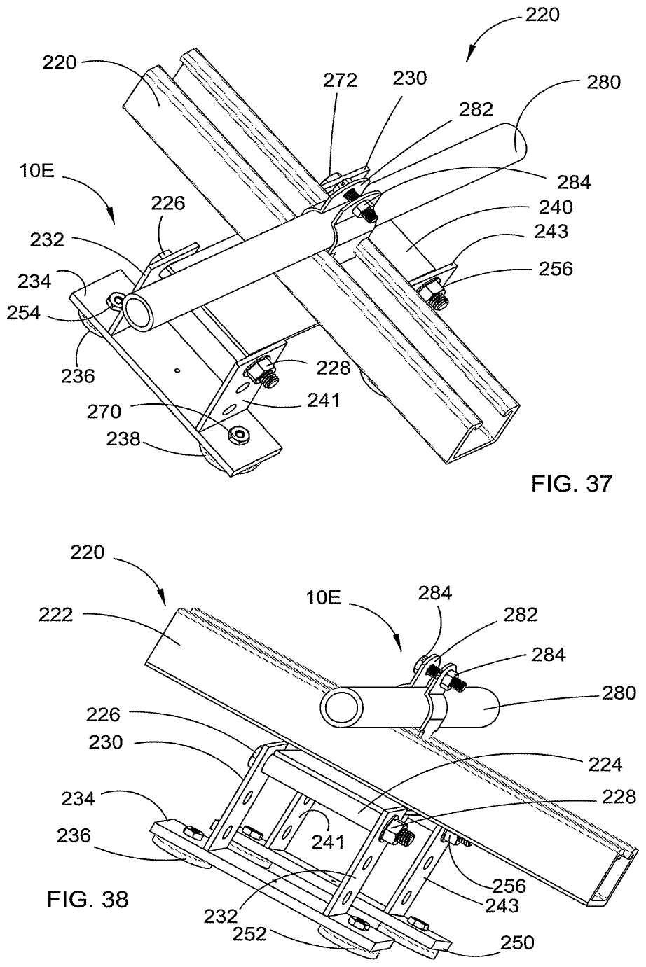

FIG. 37 depicts a top view, a side view, and a front view of a curvature-adjustable magnetic strut embodiment 10E assembly 220 having a strut securing plate 240 having two hinged bracket assemblies attached to two magnet base plates 234 and iron or carbon steel flat bar wherein a curvature value can be adjusted by rotation of the hinges (with hinge 224 shown in FIG. 24) to align the magnet base plates 234 and 278, wherein each base plate respectively has two magnets 236, 238 and 250, 252. A curvature-adjustable magnetic strut embodiment 10E assembly 220 is shown in use in FIG. 36, with a pipe, a conduit or tubing 280 securely mounted to the curvature-adjustable magnetic strut embodiment 10E assembly 220 using a conventional pipe clamp 282 and a clamp retaining bolt and nut 284. Additionally, the two hinged bracket assemblies have been rotated slightly inward to conform to the curvature of a tank surface, as seen in this view.

FIG. 38 presents a top view, a side view, and a front view of a curvature-adjustable magnetic strut embodiment 10E assembly 220 including a securing plate 240 having two hinged bracket assemblies attached to two magnet base plates 234 and 278, wherein the curvature is adjusted by rotation of the two hinges (with the hinge 224 shown in FIG. 38) to align the two magnet base plates 234 and 278, wherein each of the two base plates respectively has two magnets 236, 238 and 250, 252 thereon. In FIG. 35, the curvature-adjustable magnetic strut embodiment 10E assembly 220 is shown in use, wherein a pipe, a conduit or tubing 280 is securely mounted to the curvature-adjustable magnetic strut embodiment 10E assembly 220 using a conventional pipe clamp 282 and including a clamp retaining bolt and associated nut 284. Also, the hinged bracket assemblies have been rotated slightly inward to conform to curvature of a tank surface, as seen in this view.

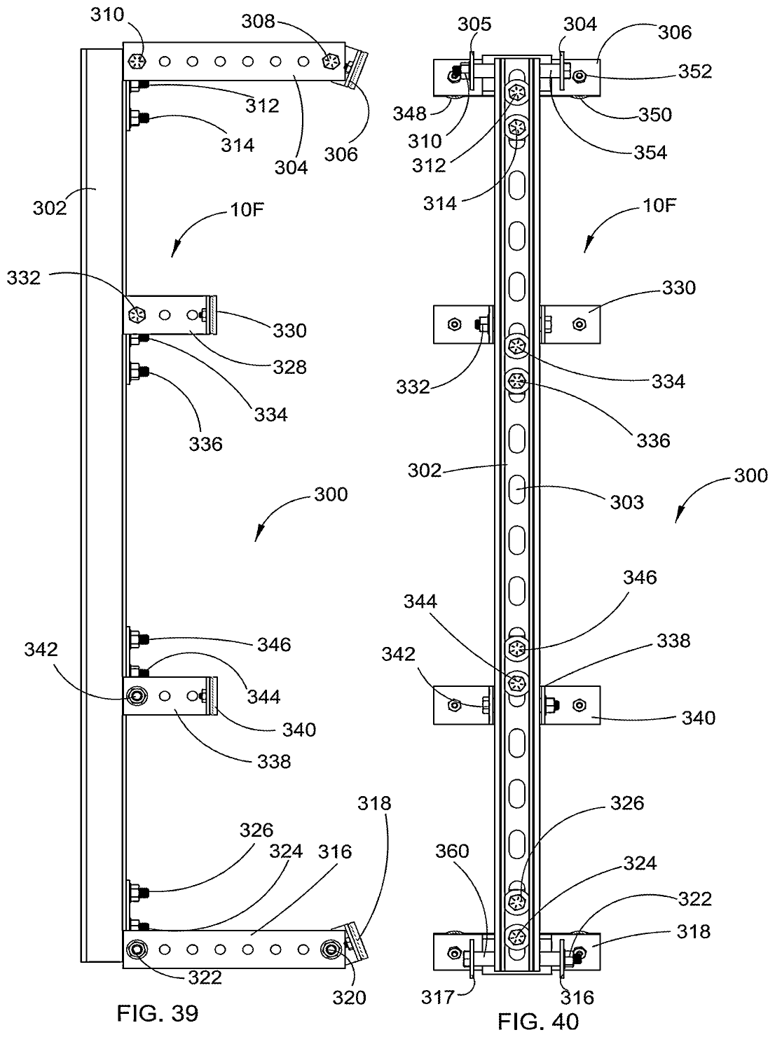

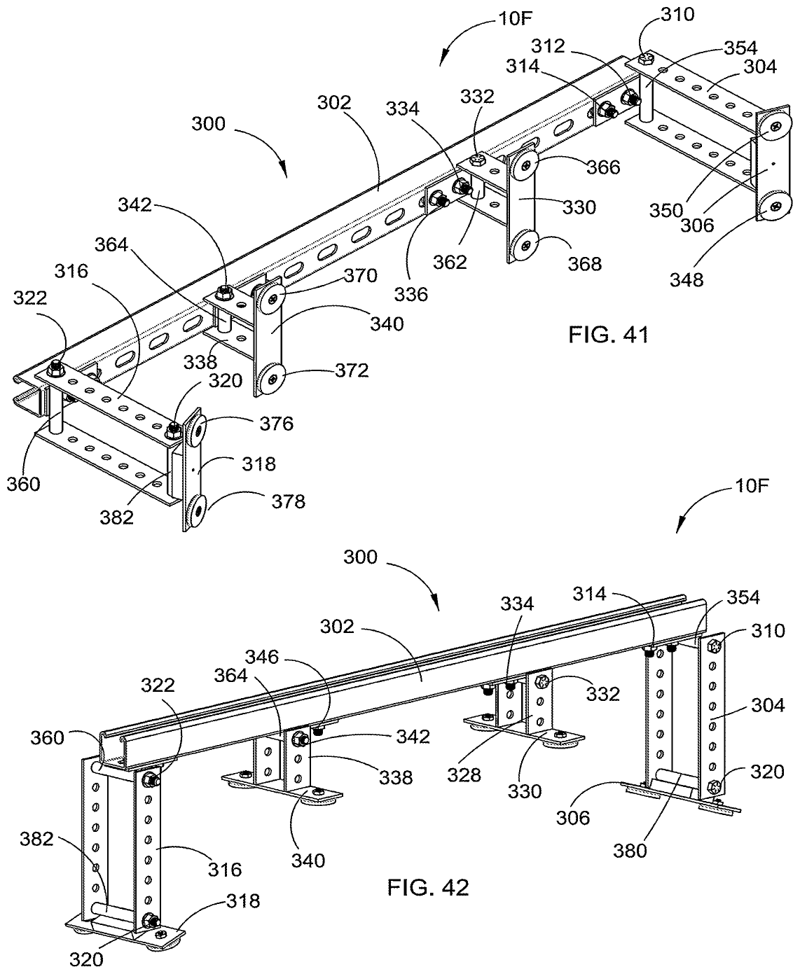

FIG. 39 is a side elevational view of a curvature-adjustable magnetic strut embodiment 10F assembly 300 with a strut 302 secured to four hinged bracket assemblies 304, 328, 338, and 316, attached to four magnet base plates 306, 330, 340, and 318, respectively, wherein the curvature is adjusted by rotation of the four hinged bracket assemblies to align the four magnet base plates, with each magnet base plate having two magnets thereon. Each of the hinged bracket assemblies 304, 328, 338 and 316 is secured to the variable length slotted strut 302 using eight strut retaining bolts 312, 314, 334, 336, 344, 346, 324, and 326. The end bracket assemblies 304 and 316 each have two hinges, 354 and 380 (not visible in FIG. 39; please refer to FIGS. 41 and 42) with hinge retaining pin bolts 308, 310 on bracket assembly 304, and with hinge retaining pin nuts 320, 322 on bracket assembly 316. Intermediary bracket assemblies 328, 338 are positioned toward the middle of slotted strut 302 and each have one hinge, 362 and 364 (not visible in FIG. 39; please refer to FIG. 41) namely, hinge retaining pin nut 332 and hinge retaining pin nut 342. On the ending bracket assemblies 304 and 316, one of the hinges 310, 322 is proximal to slotted strut 302 and another one of the hinges 308, 320 is proximal to magnet base plate 306. With intermediary bracket assemblies 328, 338 (FIG. 42) and hinges 362, 364 (FIG. 41), respectively, are positioned proximal to slotted strut 302. In this way, each of the ending bracket assemblies are two-way adjustable by rotation about each of the two hinges, while the intermediary bracket assemblies are one-way adjustable by rotation about the single hinge positioned adjacent to slotted strut 302.

FIG. 40 presents a top plan view of a curvature-adjustable magnetic strut embodiment 10F assembly 300, in accordance with the present subject matter, including a strut 302 secured to four hinged bracket assemblies 304, 328, 338, and 316, attached to four magnet base plates 306, 330, 340 and 318, respectively, wherein a preselected curvature value is adjusted by rotating the hinged bracket assemblies to align the four magnet base plates, wherein each magnet base plate has two magnets secured thereto. In FIG. 40, bracket retaining bolts 312, 314, 334, 336, 344, 346, 324 and 326 can be seen securing the bracket assemblies to the slotted strut 304. Also shown in FIG. 40, are the four magnet base plates 306, 330, 340, and 318. In operation, positioning of the hinges attached to the four bracket assemblies permits curvature adjustment of the four brackets attached to the four magnet base plates, wherein the curvature is adjusted by rotation of the four upper hinges and two lower hinges (attached to the end brackets only) to align the magnet four base plates, with each magnet base plate having two magnets thereon.

FIG. 41 depicts a bottom view, a sideview, and a front view of a curvature-adjustable magnetic strut embodiment 10F assembly 300 having a strut 302 secured to four hinged bracket assemblies 304, 328, 338 and 316, attached to four magnet base plates 306, 330, 340 and 318, respectively. Here is shown the position of the hinges 354 and 380 on bracket 304, hinges 360 and 282 on end bracket 316, as well as hinge 362 on bracket 328 and hinge 364 on bracket 338. In this view, the magnet base plates 306 and 318 on end brackets 304 and 316, respectively, have been rotated inward to adjust for the curvature of a fuel tank surface. Therefore, by rotation of the brackets and magnet base plates, the curvature-adjustable magnetic strut embodiment 10F assembly 300 is readily adjusted to vary curvature for a secure attachment to a fuel tank curved surface.

FIG. 42 depicts a top view, a side view, and a front view of a curvature-adjustable magnetic strut embodiment 10F assembly 300, in accordance with the present subject matter, including having a strut 302 secured to four hinged bracket assemblies 304, 328, 338, and 316, attached to four magnet base plates 306, 330, 340 and 318, respectively FIG. 42 clearly presents the position of the end bracket hinges, namely, hinges 354 and 380 on the bracket assembly 304, and hinges 360 and 382 on the bracket assembly 316.

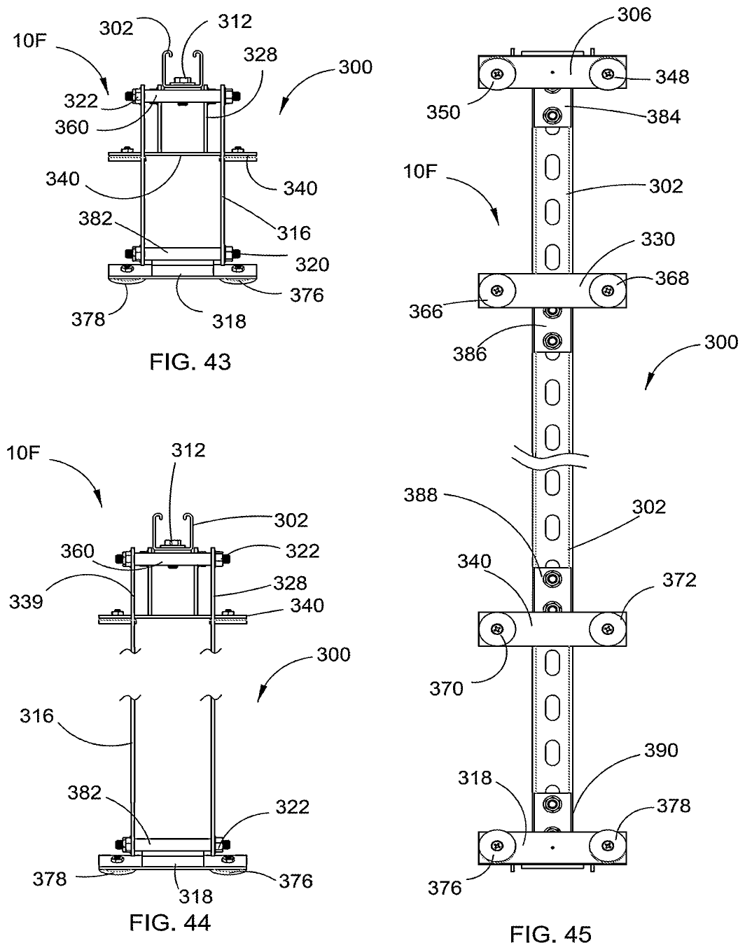

FIG. 43 depicts a front view of a curvature-adjustable magnetic strut embodiment 10F assembly 300, in accordance with the present subject matter, including a strut 302 secured to four hinged bracket assemblies 304, 328, 338, and 316, attached to the four magnet base plates 306, 330, 340, and 318, respectively, with only two bracket assemblies 316, 328 visible in FIG. 43. The strut 302 is secured to bracket assembly 316 using strut retaining bolt 312, 314 (with 314 not visible in FIG. 43), and bracket 328 using securing bolt 334, 336 (neither is visible). The location of hinges 360, 382 is shown. Hinge 360 allows rotation of the bracket assembly 316, while hinge 382 allows rotation of magnet base plate 318. In this way, curvature adjustment of the assembly 300 is enabled.

FIG. 44 depicts a rear view of a curvature-adjustable magnetic strut embodiment 10F assembly 300 having a strut 302 secured to four hinged bracket assemblies 304, 328, 338, and 316, attached to magnet base plates 306, 330, 340, and 318, respectively with only two bracket assemblies 316, 328 visible in FIG. 44, thus showing that bracket assemblies may be constructed of varying lengths as required, to adjust the assemblies 300 to curvature of fuel tanks to allow secure attachment of the magnets to a tank surface.

FIG. 45 presents a bottom view of a curvature-adjustable magnetic strut embodiment 10F assembly 300, in accordance with the present subject matter, including a strut 302, secured to which are four hinged bracket assemblies 304, 328, 338, and 316 (not shown in FIG. 45), wherein each of the bracket assemblies is attached to a respective one of four magnet base plates 306, 330, 340, and 318. Each magnet base plate 306, 330, 340, and 318 has two magnets secured thereto, with magnet base plate 306 having magnets 348 and 350, the magnet base plate 330 having magnets 366 and 368, the magnet base plate 340 having magnets 370 and 372, while the magnet base plate 318 includes magnets 376 and 378. Also shown are the securing plates 384, 386, 388, and 390 which secure the slotted strut 302 to each bracket assembly 304, 328, 338, and 316, using the strut retaining bolts 312, 314, 334, 336, 344, 346, 324, and 326 (not shown in FIG. 45; therefore, please refer to FIG. 40). FIG. 45 demonstrates that slotted strut 302 of an assembly 300 may be constructed of varying lengths as required to adjust an assembly 300 to a curvature value of a fuel tank, to allow secure attachment of magnets to a tank surface. It is therefore anticipated that a length of slotted strut 302 may vary depending on the number of pipes, conduits, and tubing to be mounted to an assembly 300 as required during the installation of any adjustable magnetic strut embodiment 10F.

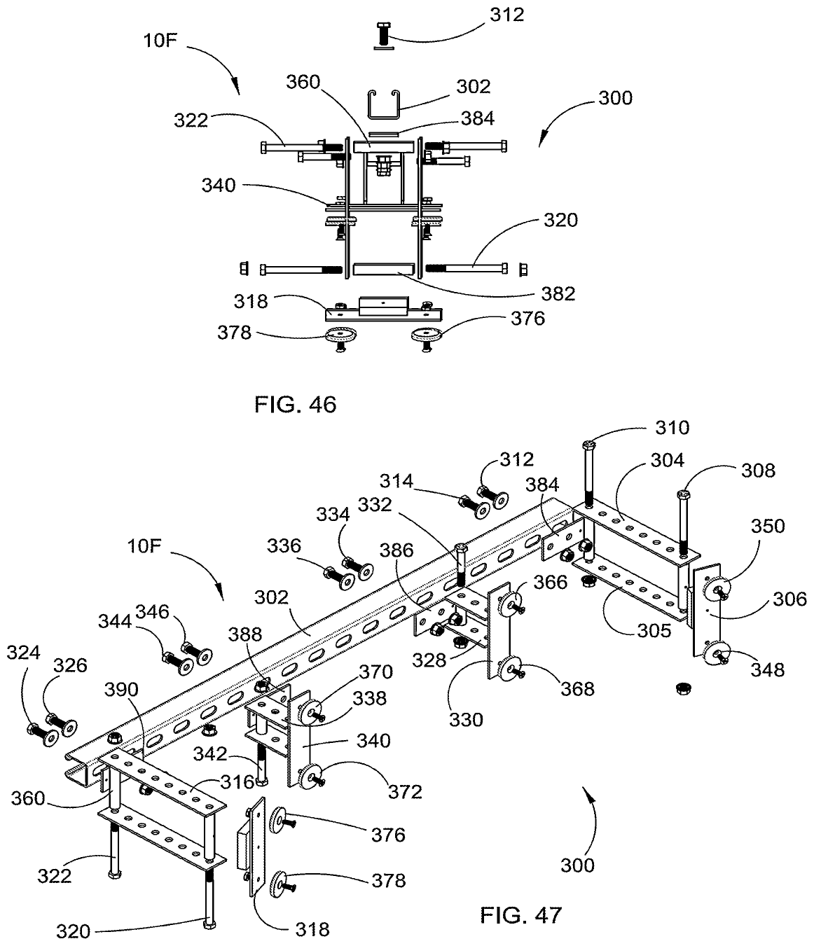

FIG. 46 is a front exploded view of a curvature-adjustable magnetic strut embodiment 10F of an assembly 300 depicting various parts making up the construction of an assembly 300. The relative locations of hinges 360 and 382, along with the magnet base plates 340 and 318, and magnets 376 and 378 when secured to the magnet base plate 318, are shown. When an assembly 300 is constructed, hinge retaining bolts 320 and 322 secure hinges 360 and 382 to the bracket assemblies and the strut retaining bolt 312 secures strut 302 to bracket assemblies by using securing plate 384 (see FIG. 45).

FIG. 47 presents a bottom view, a side view, and a front exploded view of a curvature-adjustable magnetic strut embodiment 10F assembly 300 illustrating the position of the strut securing plates 384, 386, 388, and 390 when used to secure the bracket assemblies 304, 328, 338, and 316 to the slotted strut 302 using assorted strut securing bolts 312, 314, 334, 336, 344, 346, 324, and 326. Each of the bracket assemblies 304, 328, 338, and 316 includes a magnet base plate having two magnets affixed thereto, with the magnets 348, 350 affixed to magnet base plate 306, magnets 366, 368 affixed to magnet base plate 330, magnets 370, 372 affixed to the magnet base plate 340, and the magnets 376, 378 affixed to the magnet base plate 318. In addition, the hinge pin retaining bolts 310, 312 are positioned on bracket assembly 304, the hinge pin retaining bolt 332 on bracket assembly 328, the hinge pin retaining bolt 342 on bracket assembly 338, and the hinge pin retaining bolts 320, 322 on the bracket assembly 316.

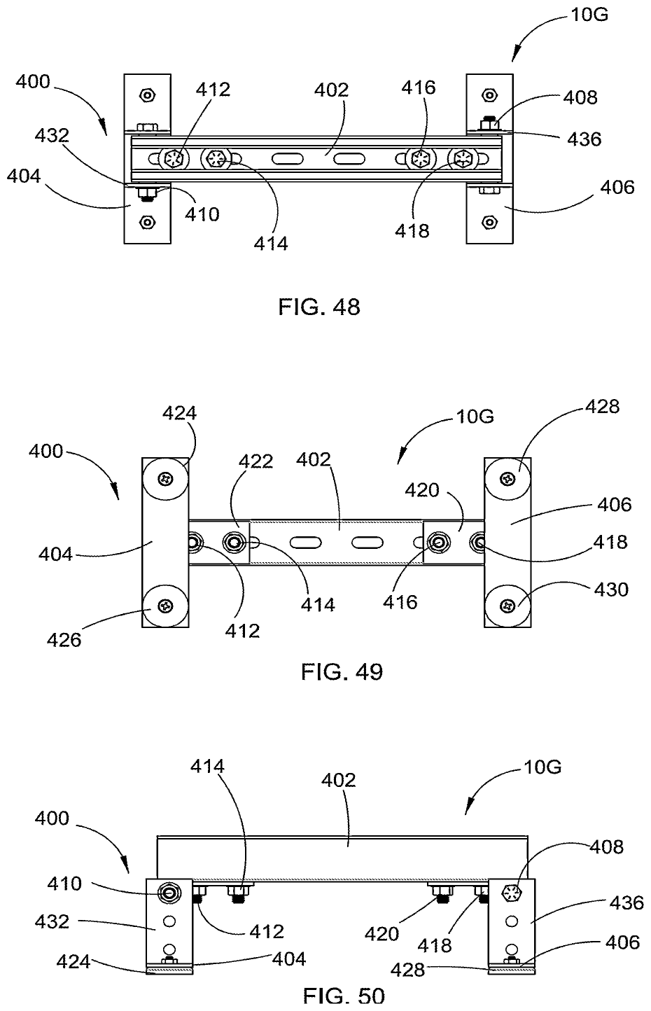

FIG. 48 is a plan view of a curvature-adjustable magnetic strut embodiment 10G assembly 400 having two single-hinged bracket assemblies 432, 436 affixed to a slotted strut 402 using strut retaining bolts 412, 414, 416, and 418. At the end of each bracket assembly is located a magnet base plate 404, 406. Each hinge (not shown in FIG. 48) on a hinged bracket assembly is secured using a hinge pin bolt 408, 410. Each magnetic base plate 404, 406 includes one or more magnets affixed thereto, as shown in FIG. 49.

FIG. 49 is a bottom view of a curvature-adjustable magnetic strut embodiment 10G assembly 400 having two single hinged bracket assemblies 432, 436 affixed to a slotted strut 402 using strut retaining bolts 412, 414, 416, and 418. At the end of each bracket assembly is located a magnet base plate 404, 406. The slotted strut 402 is secured to two bracket assembly securing plates 420, 422 which are bolted in place using strut retaining bolts 412, 414, 416, and 418. As shown in FIG. 49, each magnet base plate 404 nd 406 have two magnets affixed thereto, magnets 424, 426, 428, and 430, respectively.

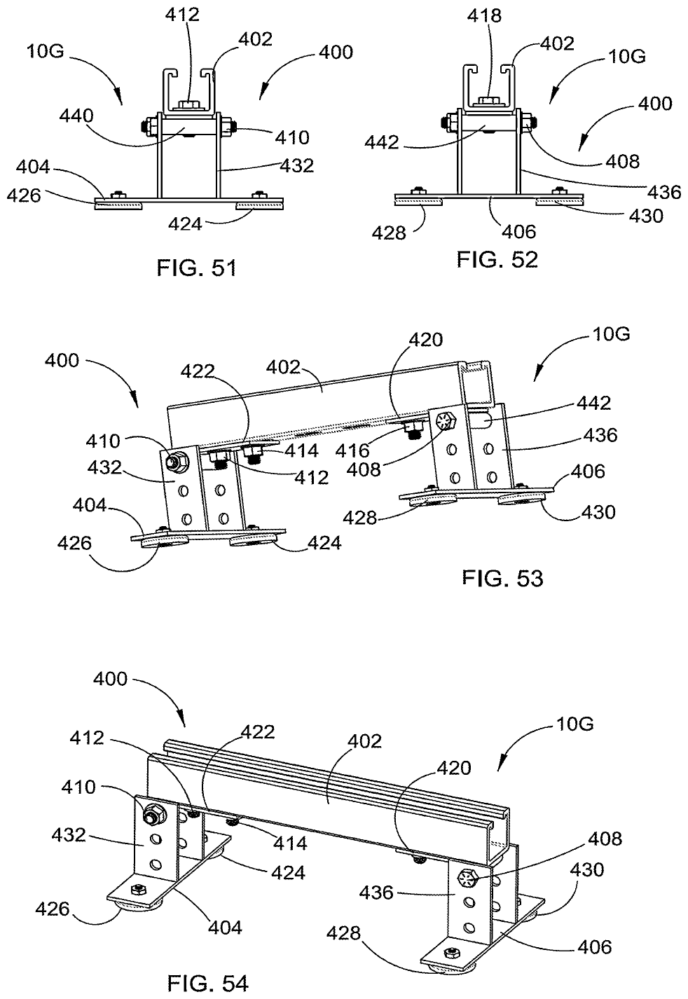

FIG. 50 depicts a side elevational view of a curvature-adjustable magnetic strut embodiment 10G assembly 400 having two single hinged bracket assemblies 432, 436 affixed to a slotted strut 402 using strut retaining bolts 412, 414, 416, and 418. At the end of each bracket assembly is located a magnet base plate 404, 406. A magnet 424 located on a magnet base plate 432 and another magnet 428 located on another magnet base plate 436 can be seen in FIG. 50 which presents the position of the hinges proximal to the strut 402 and held in place using the retaining bolts 408, 410. The hinges (not visible in FIG. 50; please refer to FIGS. 51, 52) allow rotation of the bracket assemblies 432, 436 which—in turn—allows for alignment of the magnet base plates 404, 406 to match the curvature of the fuel tank where the curvature-adjustable magnetic strut embodiment 10G assembly 400 is being installed. As a result, the magnets could be mounted flush with the tank surface for enabling maximum surface area holding by the magnets of the curvature-adjustable magnetic strut embodiment 10G assembly 400 in place on the tank surface.

FIG. 51 is a front view of a curvature-adjustable magnetic strut embodiment 10G assembly 400 having two strut-securing base plates adapted and configured for securing two hinged brackets, wherein one bracket is mounted on each end of the strut, wherein the hinged brackets each have a magnet base plate including one or more magnets, and wherein the assembly 400 includes two magnets per magnet base plate. FIG. 51 shows a relative position for hinge 440 about which a bracket assembly 432 can rotate. FIG. 51 also depicts a strut securing bolt 412, for securing strut 402 to the bracket assembly 432.

FIG. 52 depicts a rear view of a curvature-adjustable magnetic strut embodiment 10G assembly 400 having two strut-securing base plates securing two hinged brackets, wherein one hinged bracket is mounted on each end of the strut, wherein the two hinged brackets each have a magnet base plate including one or more magnets. FIG. 52, depicting two magnets per magnet base plate, better illustrates a relative position for said hinge 442 about which the bracket assembly 436 is free to rotate. Finally, FIG. 52 also depicts the strut securing bolt 418 which secures strut 402 to the bracket assembly 436.

FIG. 53 presents a bottom view, a side view, and a front view of a curvature-adjustable magnetic strut embodiment 10G assembly 400 pursuant to the present subject matter. Assembly 400 has two strut-securing base plates securing two hinged brackets, one on each end of the strut, wherein the hinged brackets each have a magnet base plate including one or more magnets, or two magnets per base plate, as are shown in FIG. 53.

FIG. 54 depicts a top view, a side view, and a front view of a curvature-adjustable magnetic strut embodiment 10G assembly 400 including two strut-securing base plates 420, 422 securing two hinged bracket assemblies 432 and 436, wherein one of each is mounted on each end of the slotted strut 402, wherein the hinged brackets 432 and 436, wherein each has a magnet base plate 404 and 406, wherein each includes one or more magnets, or two magnets per magnet base plate, as represented by the magnets 424, 426, 428, and 430. FIG. 54 better illustrates the position of the two bracket assemblies 432, 436 and hinge retaining bolts 408, 410 in relation to the position of slotted strut 402.

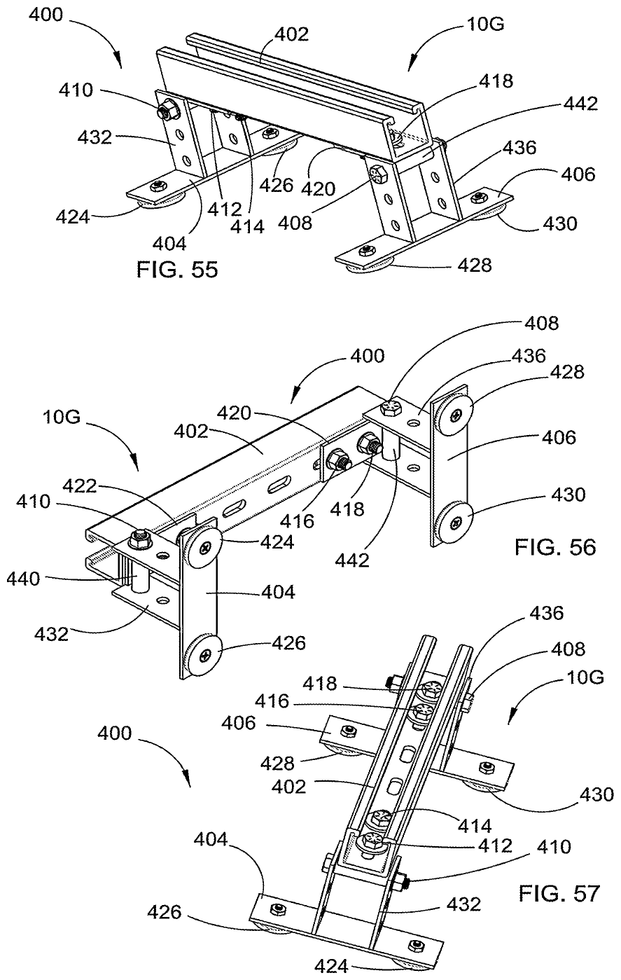

FIG. 55 depicts a top view, a side view, and a front view of a curvature-adjustable magnetic strut embodiment 10G assembly 400 having two strut-securing base plates 420, 422 securing two hinged bracket assemblies 432 and 436, one of each mounted on each end of the slotted strut 402, wherein the hinged brackets 432 and 436 each have a magnet base plate 404 and 406 each including one or more magnets, or two magnets per magnet base plate, as represented by magnets 424, 426, 428, and 430. FIG. 55 also illustrates a location for the two bracket assemblies 432, 436 and the hinge retaining bolts 408 and 410 in relation to the position of the slotted strut 402 as well as one of the two hinges 442.

FIG. 56 presents a bottom view, a side view, and a front view of a curvature-adjustable magnetic strut embodiment 10G assembly 400 pursuant to the present subject matter including two strut-securing base plates 420 and 422 securing two hinged bracket assemblies 432 and 436, wherein one of each is mounted on one of the ends of a slotted strut 402, wherein the hinged brackets 432, 436 each have a magnet base plate 404, 406 each of which includes one or more magnets, specifically two magnets per magnet base plate, as shown by the magnets 424, 426, 428, and 430. FIG. 56 better illustrates the location of two bracket assemblies 432, 436 and the hinge retaining bolts 408, 410 in relation to locations for slotted strut 402, in view of possible locations for hinges 440, 442.

FIG. 57 presents a top view, a side view, and a front view of a curvature-adjustable magnetic strut embodiment 10G assembly 400 having two strut securing base plates 420, 422 securing two hinged bracket assemblies 432 and 436, wherein one of each is mounted on one of the opposite end portions of the slotted strut 402, wherein the hinged brackets 432, 436 each have a magnet base plate 404, 406 each including one or more magnets, or two magnets per magnet base plate, as represented by magnets 424, 426, 428, and 430. FIG. 57 better illustrates the two bracket assemblies 432, 436 embodiment which includes bracket retaining bolts 412, 414, 416, and 418 in relation to positions for slotted strut 402, in view of possible locations for the hinge pin retaining bolts 408, 410.

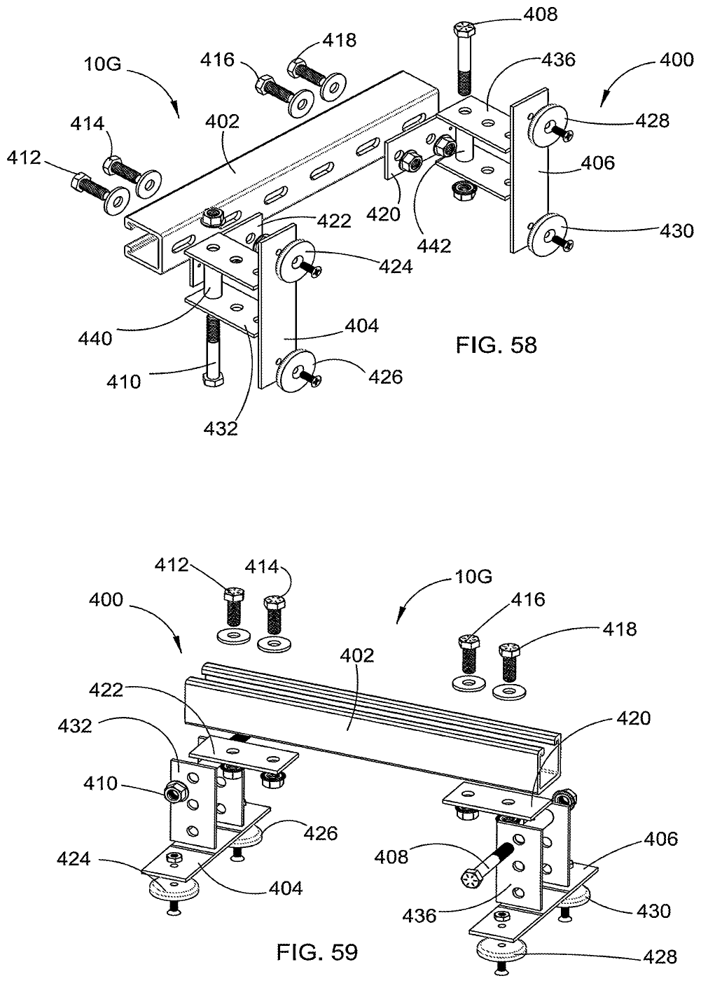

FIG. 58 presents a bottom view, a side view, and a front exploded view of a curvature-adjustable magnetic strut embodiment 10G assembly 400 having two strut securing base plates 420 and 422 securing two hinged bracket assemblies 432 and 436, one of each mounted on each end of the slotted strut 402, wherein the hinged brackets 432 and 436 each have a magnet base plate 404 and 406 each including one or more magnets, here having two magnets per magnet base plate, as represented by magnets 424, 426, 428, and 430. This exploded view of FIG. 58 better illustrates the two magnet base plates 404 and 406 and the two magnets affixed to the two magnet base plates 404 and 406, namely, magnets 424, 426, 428, and 430. It also illustrates that the four strut securing plate bolts 412, 414, 416, and 418 which affix the two bracket assemblies 432 and 436 pass through the slots in the slotted strut 402, then through orifices in the strut securing plates 420 and 422 to attach the bracket assemblies rotatably to the hinges 440 and 442. The strut securing plates 420 and 422 are welded to the hinges 440 and 442 before the hinges are mounted to the brackets by using the hinge pin bolts 408 and 410.

FIG. 59 presents a top view, a side view, and a front exploded view of a curvature-adjustable magnetic strut embodiment 10G assembly 400 having two strut securing base plates 420 and 422 securing two hinged bracket assemblies 432 and 436, one of each mounted on each end of the slotted strut 402, wherein the hinged brackets 432, 436 each have a magnet base plate 404, 406 each including one or more magnets, or two magnets per magnet base plate, as represented by magnets 424, 426, 428, and 430. FIG. 58 therefore better illustrates the two strut securing plates 420, 422 and the four strut securing plate bolts 412, 414, 416, and 418 which affix the two bracket assemblies 432, 436. Also shown in FIG. 59 are four magnets 424, 426, 428, and 430 affixed to two magnet base plates 404, 406. When assembled, the four strut securing plate bolts 412, 414, 416, and 418 are secured to the two bracket assemblies 432, 436 and pass through the slots in the slotted strut 402, and also pass through the orifices in the strut securing plates 420, 422 to attach the bracket assemblies rotatably to hinges 440, 442. Then, the strut securing plates 420, 422 are welded to the hinges 440, 442 before the hinges are mounted to the brackets using the hinge pin bolts 408 and 410. In this way, the bracket assemblies are free to rotate about the hinges and to align with the curved surface of a curved fuel tank.

In summary, for the curvature-adjustable magnetic strut assemblies 10E, 10F, and 10G, these embodiment of the present subject matter are designed, adapted, and configured to be constructed from slotted strut of variable length; two or more single-or double-hinged bracket assemblies; magnet base plates attached to each of the 2 to 4, or more, variable-length, single-or double-hinged bracket assemblies; and magnets fixed to the magnet base plates in such a way that hinges allow rotation of the brackets to conform to a curved surface for mounting the magnets of the curvature-adjustable magnetic strut assemblies 10E, 10F, and 10G to a fuel storage tank to accomplish a secure installation of a strut for securing pipe, conduit and tubing thereon. A way in which these embodiments are constructed and operate make them equally applicable to use on curved tank surfaces as well as flat tank surfaces, to enable installation on a surface portion of any type of tank.

The Curvature-adjustable Magnetic Strut primary features will include as prominent design and operational features:
a variable length strut member with securing strut base plates;
one or more magnet base plates affixed to the variable length strut member;
two or more magnets attached to each magnet base plate;
two or more strut base plates secured single hinged bracket assemblies including one or more magnetic base plates affixed to each bracket assembly; and
two or more strut base plates secured double hinged bracket assemblies including one or more hinged magnetic base plates affixed to each hinged bracket assembly having a hinged magnetic base plate.

Curvature-adjustable Magnetic Strut Assemblies 10A, 10B, 10C, 10D, 10E, 10F and 10G shown in the FIGS. and described herein disclose components of predetermined configuration for purposes of illustrating an assortment of embodiments of structural details associated with the present subject matter. It is to be understood, moreover, that a different construction and configuration of components and other arrangements thereof, other than those illustrated and described herein could be employed for purposes of providing a Curvature-adjustable Magnetic Strut 10A, 10B, 10C, 10D, 10E, 10F, and 10G in accordance with the spirit of this disclosure, and that such changes, alternations and/or modifications as would occur to a person of ordinary skill in the art are considered to be within the scope of the present subject matter as broadly defined in the appended claims.

While various embodiments of the present subject matter are described herein, such embodiments have been presented by way of example only and are not intended to limit the scope of the present subject matter. Indeed, the novel methods including methods of assembly, assemblies, combinations, and systems described herein may be embodied in a variety of other forms. Furthermore, various omissions, substitutions and changes in the systems and methods described herein may be made without departing from the spirit of this disclosure. For example, one portion of one of the embodiments described herein can be substituted for another portion in another embodiment described herein. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood as applicable to any other aspect, embodiment, or example described in this section or elsewhere in this specification unless incompatible therewith. All features and advantages disclosed in this patent specification including any accompanying claims, abstract, drawings, and/or steps of any method or process disclosed, may be combined in any combination, except for combinations where at least some of such features or advantages are mutually exclusive.

Patent protection is not restricted to details of any foregoing embodiments. Rather, patent protection extends to any novel feature, or any novel combination, of features disclosed in this patent specification including accompanying claims, abstract, FIGS, method step and/or combination of features and/or advantages, as set forth in the appended claims.

Furthermore, certain features that are described in this disclosure including this patent specification and its FIGS, in the context of separate implementations can be implemented in combination in a single implementation. Conversely, features that are described in the context of a single implementation may be implemented in multiple implementations separately or in one or more patently protectable sub-combinations.

Also, although features may be described as supporting one or more combinations, one or more features of a claimed combination can be excised from a combination, enabling the combination to be claimed as a sub-combination or as a sub-combination variation.

Moreover, while operations may be depicted in the drawings or described in the specification in a particular order, such operations need not be performed in sequential order shown in FIGS or described in the specification, or that all operations be performed, to achieve results described herein. Other operations, not depicted or described, can be incorporated in an example of such methods or processes. For example, one or more additional operations can be performed before, after, simultaneously, or between any of operations described in the specification. Furthermore, the operations described in the specification operations may be rearranged, thereby resulting in various other implementations. A person of ordinary skill in the art (“POSITA”) will appreciate that in some embodiments, actual steps taken in processes illustrated or disclosed may differ from those shown in the FIGS. Depending on an embodiment, certain steps described above may be removed, while others may be added. Furthermore, features and attributes of the specific embodiments disclosed hereinabove may be combined in different ways to form various additional embodiments, all of which fall within the scope of the present disclosure. Also, a separation of various system components in implementations noted above should not be understood as requiring such separation in all implementations, and it should furthermore be understood that above-described components and systems can generally be integrated together in a single product or packaged into multiple products.

Aspects, features, advantages, and novel features of the present subject matter are described herein. All such aspects, features, advantages, and novel features may not be achieved in accordance with any embodiment. Thus, for example, a person of ordinary skill in the art (“POSITA”) will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included to be used or are to be performed in embodiments disclosed.

Conjunctive language such as the phrase “at least one of X, Y, and Z,” unless specifically stated otherwise, is otherwise understood with the context as used in general to convey that an item, a term, and so forth may be either “X,” “Y,” or “Z.” Therefore, use of such conjunctive language is not generally intended to imply that certain embodiments require the presence of at least one of “X,” at least one of “Y,” and at least one of “Z.”

Language of degree used herein, such as the terms “approximately,” “about,” “generally,” and “substantially” as used throughout this specification represent a value, an amount, or a characteristic close to a stated value, a stated amount, or a stated characteristic that performs a desired function or achieves a desired result. For example, the terms “approximately,” “about,” “generally,” and “substantially” may refer to an amount that is within less than about 10% of, within less than about 5% of, within less than about 1% of, within less than about 0.1% of and within less than about 0.01% of a stated amount. As another example, in embodiments, the terms “generally parallel” and “substantially parallel” refer to a value or an amount that departs from exactly parallel by less than or equal to about 10 degrees, 5 degrees, 3 degrees, 1 degree, or 0.1 degree.

The scope of the present disclosure is not intended to be limited by the specific disclosures of preferred embodiments throughout this section or elsewhere throughout this patent specification, and the scope of the present disclosure may be defined by claims as presented in this section or elsewhere in this specification or as presented in the future. The language of the claims is to be interpreted broadly based on language employed in the claims and not limited to the examples described in the present specification or during the prosecution of the application, which examples are to be construed as non-exclusive.

Moreover, a purpose of the foregoing abstract is to enable the U.S. Patent and Trademark Office, foreign patent offices worldwide and the public generally, and especially scientists, engineers and practitioners in the art who are not familiar with patent claims, legal terms or phraseology, to determine quickly from a cursory inspection the nature and essence of the technical disclosure of the application. An abstract is not intended to define an invention, where invention is measured by the claims, nor is the abstract intended to be limiting as to the scope of the present subject matter in any way.

I claim:

1. A curvature adjustable magnetic strut, comprising:
(a) a strut section having a upper portion and a lower portion, and a spanning base plate member having an upper surface and a lower surface, wherein said strut section lower portion is secured to said spanning base plate member upper surface;
(b) two bracket assemblies having an upper portion and lower portion wherein said two bracket assemblies upper portion each includes a hinge thereon, and said hinge is affixed to said lower surface of said spanning plate member;
(c) two magnet base plates secured to said two bracket assemblies lower portion; and
(d) two magnets affixed to each of said two magnet base plates;
wherein said bracket assemblies are curvature adjustable by rotation about the hinges thereon.

2. The curvature adjustable magnetic strut according to claim 1, wherein said strut section includes a slotted strut having a plurality of orifices, and is secured to said spanning plate member using strut securing bolts and corresponding strut securing nuts.

3. The curvature adjustable magnetic strut according to claim 1, wherein said hinge includes a hinge pin bolt and a hinge pin nut, and further wherein said hinge is secured to said spanning plate member by welding.

4. The curvature adjustable magnetic strut according to claim 1, wherein said two magnets affixed to said magnet base plate are affixed to the magnet base plate using magnet retaining screws and corresponding magnet retaining nuts.

5. A curvature adjustable magnetic strut, comprising:
(a) a variable length slotted strut section having a upper portion and a lower portion, and including a plurality of orifices therein;
(b) two end double hinged variable length bracket assemblies having a strut securing plate member and located on the ends of said strut section,
wherein said two end double hinged variable length bracket assemblies each have an upper portion and lower portion, and further wherein said two end double hinged variable length bracket assemblies upper portion and lower portion each includes a hinge thereon and said hinge is affixed to said lower surface of said securing plate member;
(c) two intermediary single hinged bracket assemblies having a strut securing plate member and located between the ends of said strut section, wherein said two intermediary single hinged bracket assemblies each have an upper portion and lower portion, and further wherein said two intermediary single hinged bracket assemblies upper portion each includes a hinge thereon, and said hinge is affixed to said lower surface of said securing plate member;
(d) a magnet base plate secured to the lower portion of each of said two double hinged variable length end bracket assemblies lower portion and said two intermediary single hinged bracket assemblies lower portion; and
(e) two magnets affixed to each of said magnet base plates;
wherein said two end double hinged variable length bracket assemblies are curvature adjustable by rotation about the two hinges located on said two end double hinged variable length bracket assemblies, and said two intermediary single hinged bracket assemblies are curvature adjustable by rotation about the single hinge located on said two intern1ediary single hinged bracket assemblies.

6. The curvature adjustable magnetic strut according to claim 5, wherein said hinges located on the upper portion of said two end double hinged variable length bracket assemblies and said hinges located on the upper portion of said two intermediary single hinged bracket assemblies each includes a hinge pin bolt and a hinge pin nut, and further wherein said hinge is welded to said securing plate members such that each of said hinges allows rotation of each of the bracket assemblies about said hinge.

7. The curvature adjustable magnetic strut according to claim 5, wherein said hinges located on the upper portion of said two intermediary single hinged bracket assemblies each are welded to said securing plate member.

8. The curvature adjustable magnetic strut according to claim 5, wherein said hinges located on the lower portion of said two end double hinged variable length bracket assemblies each are welded to said magnet base plate.

9. The curvature adjustable magnetic strut according to claim 5, wherein said two magnets affixed to said magnet base plate are affixed to the magnet base plate using magnet retaining screws and corresponding magnet retaining nuts.

10. A curvature adjustable magnetic strut, comprising:
(a) a slotted strut section having a upper portion and a lower portion, and including a plurality of orifices therein;
(b) two end single hinged bracket assemblies having a strut securing plate member and located on the ends of said strut section, wherein said two single hinged bracket assemblies each have an upper portion and lower portion, and further wherein said two bracket assemblies upper portion each includes a hinge and said hinge is affixed to said lower surface of said securing plate member;
(c) one magnet base plate secured to the lower portion of each of said two end single hinged bracket assemblies lower portion; and
(d) two magnets affixed to each of said magnet base plates;
wherein said two end single hinged bracket assemblies are curvature adjustable by rotation about the single hinges located on said two end single hinged bracket assemblies.

11. The curvature adjustable magnetic strut according to claim 10, wherein said hinges located on the upper portion of said two end single hinged bracket assemblies each includes a hinge pin bolt and a hinge pin nut.

12. The curvature adjustable magnetic strut according to claim 10, wherein said hinges located on the upper portion of said two end single hinged bracket assemblies each are welded to said securing plate member such that each of said hinges allows rotation of the bracket assembly about said hinge.

13. The curvature adjustable magnetic strut according to claim 10, wherein said hinges located on the lower portion of said two end single hinged bracket assemblies each are secured to said magnet base plate by welding.

14. The curvature adjustable magnetic strut according to claim 10, wherein said two magnets affixed to said magnet base plate are affixed to the magnet base plate using magnet retaining screws and corresponding magnet retaining nuts.
